(19) United States
(12) Patent Application Publication
(10) Pub. No.: US 2008/0174790 A1
(43) Pub. Date: Jul. 24, 2008

(54) Image processing system, image processing method, and computer readable medium

(75) Inventors: Takeshi Noguchi, Kanagawa (JP); Junichi Matsunoshita, Kanagawa (JP); Takeshi Onishi, Kanagawa (JP); Hirofumi Komatsubara, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 11/902,152

(22) Filed: Sep. 19, 2007

(30) Foreign Application Priority Data
Jan. 18, 2007 (JP) 2007-009283

(51) Int. Cl. G06F 3/12

(52) U.S. Cl. 358/1.1

(57) ABSTRACT

An image processing system includes: an extracting unit that extracts page identification information from image information; an acquiring unit that acquires document identification information corresponding to the page identification information on the basis of the page identification information extracted by the extracting unit; a classifying unit that classifies the image information on the basis of the document identification information acquired by the acquiring unit; and a first generating unit that generates the image information classified by the classifying unit as one electronic document.

### CROSS-REFERENCE TO RELATED APPLICATIONS

This application is based on and claims priority under 35 U.S.C. 119 from Japanese Patent Application No. 2007-009283 filed Jan. 18, 2007.

### BACKGROUND

1. Technical Field

The present invention relates to an image processing system, an image processing method, and a computer readable medium.

2. Related Art

Nowadays, in system environments in which client PCs, image forming apparatuses such as printers, multi function copiers and the like, document management servers, etc. are installed in offices and soon, there is a growing tendency to intensify document security for various processes such as printing electronic document data on recording medium (sheet), scanning-in documents printed on sheet, copying or transmitting scanned-in image data and the like.

### SUMMARY

According to an aspect of the present invention, an image processing system includes: an extracting unit that extracts page identification information from image information; an acquiring unit that acquires document identification information corresponding to the page identification information on the basis of the page identification information extracted by the extracting unit; a classifying unit that classifies the image information on the basis of the document identification information acquired by the acquiring unit; and a first generating unit that generates the image information classified by the classifying unit as one electronic document.

### BRIEF DESCRIPTION OF THE DRAWINGS

Exemplary embodiment of the present invention will be described in detail based on the following figures, wherein:

FIG. 1 is a block diagram showing the entire configuration of an image processing system related to the invention;

FIG. 2 is a block diagram showing a functional configuration of a client terminal in FIG. 1;

FIG. 3 is a block diagram showing a functional configuration of a document managing apparatus in FIG. 1;

FIG. 4 is a block diagram showing a functional configuration of an image forming apparatus in FIG. 1;

FIG. 5 is a block diagram showing a functional configuration of a user attribute information managing apparatus in FIG. 1;

FIG. 6 is a block diagram showing a functional configuration of a policy managing apparatus in FIG. 1;

FIG. 7 is a view showing a control sequence related to an electronic document registering process according to a first embodiment;

FIG. 8 is a table diagram showing an example of information registered in a registration document attribute managing table;

FIG. 9 is a view showing a control sequence related to an electronic document printing process according to the first embodiment;

FIG. 10 is a conceptual view showing an example of a sheet document print output by the image forming apparatus;

FIG. 11 is a table diagram showing an example of information stored in a print document attribute managing table;

FIG. 12 is a view showing a control sequence related to a sheet document scanning process according to the first embodiment;

FIG. 13 is a view showing a control sequence related to a document file generating process in S330 of FIG. 12;

FIG. 14 is a conceptual view showing an example of the sheet document scanning process according to the first embodiment;

FIG. 15 is a view showing a control sequence related to a scan document file registering process as an example of the process in S340 of FIG. 12;

FIG. 16 is a table diagram showing an example of registration information of the registration document attribute managing table after the document file registration process in FIG. 15;

FIG. 17 is a view showing a control sequence related to a scan document file printing process as an example of the process in S340 of FIG. 12;

FIG. 18 is a table diagram showing an example of information stored in the registration document attribute managing table and the print document attribute managing table after the scan document printing process in FIG. 17;

FIG. 19 is a view showing a control sequence related to a document file generating process according to a second embodiment;

FIG. 20 is a conceptual view showing an example of a sheet document scanning process according to the second embodiment;

FIG. 21 is a view showing a control sequence related to a document file generating process according to a third embodiment;

FIG. 22 is a view showing a control sequence related to a document file generating process according to a fourth embodiment; and

FIG. 23 is a view showing a control sequence related to a document file generating process according to a fifth embodiment.

### DETAILED DESCRIPTION

Hereinafter, exemplary embodiments of the invention will be described with reference to the accompanying drawings.

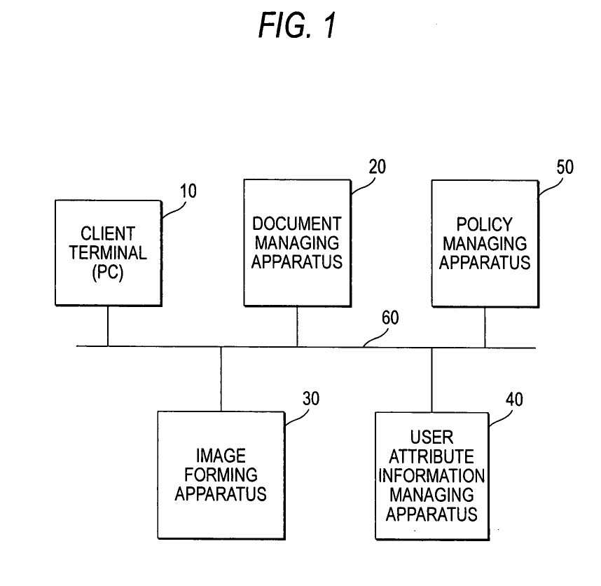

FIG. 1 is a block diagram showing the entire configuration of an image processing system related to the invention.

The image processing system includes a client terminal 10, a document managing apparatus 20, an image forming apparatus 30, a user attribute information managing apparatus 40, a policy managing apparatus 50 which are interconnected via a network (NW) 60 such as a LAN (Local Area Network), a WAN (Wide Area Network) or the like.

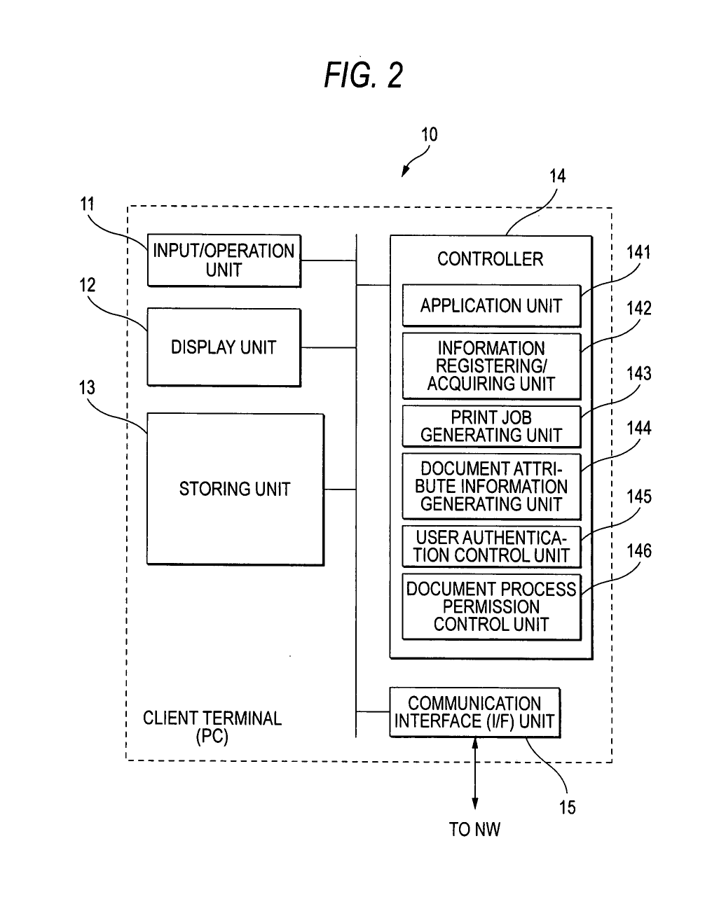

Each apparatus includes a CPU (Central Processing Unit), a ROM (Read Only Memory) or a RAM (Random Access Memory) as a main memory unit, a hard disk as a peripheral memory unit, a communication interface, etc., functional configurations of which will be described with reference to FIGS. 2 to 6.

FIG. 2 is a block diagram showing a functional configuration of the client terminal 10 in FIG. 1.

The client terminal 10, which is realized by a general purpose computer such as a PC (Personal Computer), includes an input/operation unit 11 such as in input device, for example, a keyboard, a mouse, etc., a display unit 12 that displays a variety of information such as operation guidance, operation conditions and so on, a storing unit 13 that stores a variety of information such as operating programs and so on, a controller 14 that controls all the units, and a communication interface (I/F) unit 15 that interfaces with the document managing apparatus 20, the image forming apparatus 30, the user attribute information managing apparatus 40, the policy managing apparatus 50, etc. for communication therewith via the network 60, as shown in FIG. 2.

In the client terminal 10, the controller 14 includes an application unit 141 that performs processes related to various operations (such as creation, storage, display, edition, print instruction and so on) of a document file (electronic document data: hereinafter referred to as electronic document) an so on according to user's operation through the input/operation unit 11, an information registering/acquiring unit 142 that registers/acquires information of the electronic document and so on into/from the document managing apparatus 20 according to user's operation through the input/operation unit 11, a print job generating unit 143 that generates a print job, which includes print data of the electronic document to be printed, and an instruction to print the print data, and sends the generated print job to the image forming apparatus 30, based on a print instruction from the input/operation unit 11, a document attribute information generating unit 144 that generates document attribute information corresponding to the electronic document to be registered by the information registering/acquiring unit 142 or to be printed according to the electronic document print instruction by the print job generating unit 143, a user authentication control unit 145 that performs user authentication in cooperation with the user attribute information managing apparatus 40, which will be described later, for processes (read, edition, registration, print and so on) of the electronic document, and a document permission control unit 146 that acquires authority information from the policy managing apparatus 50 in processing the electronic document and performs document process permission control to determine whether to permit or inhibit the document process based on the acquired authority information.

The document attribute information generating unit 144 generates registration document attribute information, as the document attribute information, including a document ID identifying the electronic document in registering the electronic document into the document managing apparatus 20.

In addition, when the image forming apparatus 30 is instructed to print the electronic document generated or acquired (from the document managing apparatus 20, for example), the document attribute information generating unit 144 generates print document attribute information including document identification information (document ID) identifying the electronic document of the print source, page identification information (page ID) identifying pages of the electronic document, logical page number information of the pages, etc.

When the input/operation unit 11 is manipulated to register a desired electronic document, the information registering/acquiring unit 142 sends a registration request for the electronic document to the document managing apparatus 20 to register the electronic document, and, according to the registering process, sends a registration request for registration document attribute information on the registered electronic document, which is generated by the document attribute information generating unit 144, and various meta data related to the registration to the document managing apparatus 20 to register the registration document attribute information and the meta data.

In addition, when the input/operation unit 11 is manipulated to print the electronic document, the print job generating unit 143 generates a print job for the electronic document to be sent to the image forming apparatus 30 which then prints and outputs the electronic document.

In this printing process, according to the print instruction for the electronic document, the information registering/acquiring unit 142 sends a registration request for print document attribute information on the printed electronic document, which is generated by the document attribute information generating unit 144, and various meta data related to the print to the document managing apparatus 20 to register the print document attribute information and the meta data.

Here, the document attribute information generating unit 144 generates page identification information (page ID) identifying pages of the printed electronic document and logical page number information of the pages as the print document attribute information.

For example, Hash values calculated based on electronic document data of pages of the printed electronic document are used as page IDs of the pages.

In generating the print job according to the print instruction for the electronic document from the input/operation unit 11, the print job generating unit 143 acquires the page IDs generated by the document attribute information generating unit 144, generates the print job including a drawing instruction to give (draw) the page IDs to the document data of the pages, and sends the generated print job to the image forming apparatus 30 which then prints and outputs the electronic document.

For example, an instruction to draw the page IDs as QR codes corresponding to Hash values calculated based on the document data of the pages may be employed as the drawing instruction of the page IDs.

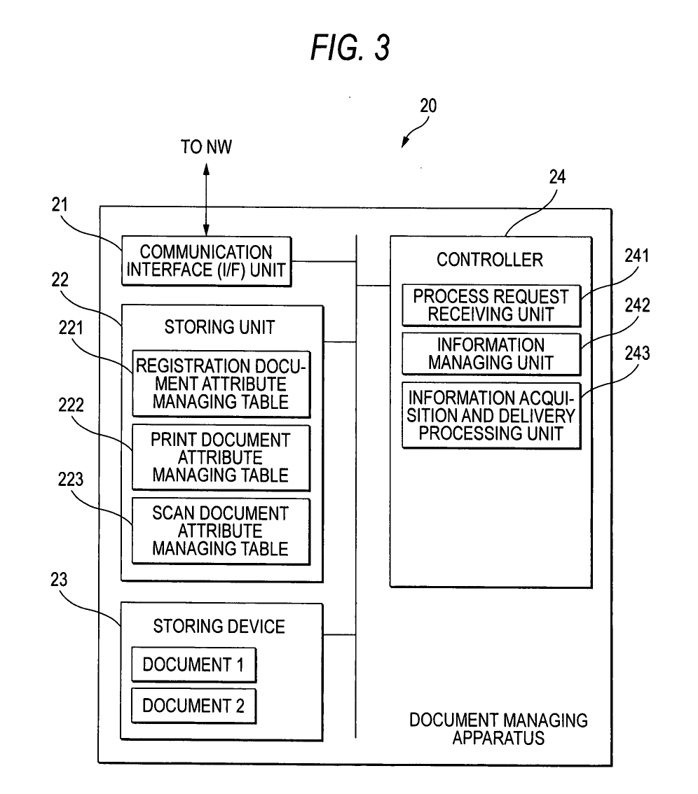

FIG. 3 is a block diagram showing a functional configuration of the document managing apparatus 20 in FIG. 1.

The document managing apparatus 20, which is realized by a general purpose computer, includes a communication interface (I/F) unit 21 that interfaces with the client terminal 10, the image forming apparatus 30, the user attribute information managing apparatus 40, the policy managing apparatus 50, etc. For communication therewith via the network 60, a storing unit 22 that stores a variety of information such as operating programs and so on, a storing device 23 such as a hard disk drive (HDD) that stores information of an electronic document and the like whose registration is requested from the client terminal 10, and a controller 24 that controls all of the unit and device, as shown in FIG. 3.

The controller 24 includes a process request receiving unit 241, an information managing unit 242 and an information acquisition and delivery processing unit 243.

The process request receiving unit 241 receives a registration or acquisition request for a variety of information from the client terminal 10, the image forming apparatus 30 and so on and instructs the information managing unit 242 or the information acquisition and delivery processing unit 243 to perform the requested information registration or information search.

Based on the information registration instruction from the process request receiving unit 241, the information managing unit 242 registers the requested information in the storing unit 22 or the storing device 23 and manages the registered information.

Based on the information search instruction from the process request receiving unit 241, the information acquisition and delivery processing unit 243 searches the requested information from the storing unit 22 or the storing device 23 and delivers the searched information to the request source.

Specifically, upon receiving a registration request of the electronic document generated by the application unit 141 (or acquired by the document managing apparatus 20) from the client terminal 10, the information managing unit 242 stores the electronic document in a predetermined region of the storing device 23, receives a registration request of the registration document attribute information sent from the client terminal 10, and registers the registration document attribute information (document ID generated by the document attribute information generating unit 144 for registration of the electronic document, etc.) and electronic document meta data (storing site, creation date, creator, etc. of the electronic document) related to the registration in, for example, a registration document attribute managing table (TB) 221 provided in the storing unit 22.

In addition, the information managing unit 242 instructs the image forming apparatus 30 to print the electronic document generated or acquired by the client terminal 10, receives a registration request of the print document attribute information generated by the document attribute information generating unit 144, which is sent according to a process of printing the electronic document as a sheet document having page IDs for pages, and registers the print document attribute information [document ID of the electronic document of the print source, page IDs corresponding to pages of the electronic document, logical page number information, etc.] and document meta data [apparatus (image forming apparatus) IDs of a print site, print date, etc.] related to the registration in, for example, a registration document attribute managing table (TB) 222 provided in the storing unit 22.

In addition, upon receiving a registration request of a scan document generated from read image data (scan data) acquired by reading and scanning the sheet document having page IDs by the image forming apparatus 30 from the image forming apparatus 300, the information managing unit 242 stores the scan document in a predetermined region of the storing device 23, receives a registration request of the scan document attribute information sent according to the scan document registration request, and registers the scan document attribute information (document ID of the scan document, etc.) and electronic document meta data (storing site of the scan document, apparatus (image forming apparatus) ID of a scan source, scan date, etc.) related to the scan in, for example, a scan document attribute managing table (TB) 223 provided in the storing unit 22.

Here, the tables 221, 222 and 223 in the storing unit 22 need not be provided individually but may be arranged into one table.

The main point is that it may be configured to generate document IDs every time in derivative processes such as registration, print and scan of the electronic document and manage document attribute of documents (derivative documents) generated in the derivative processes.

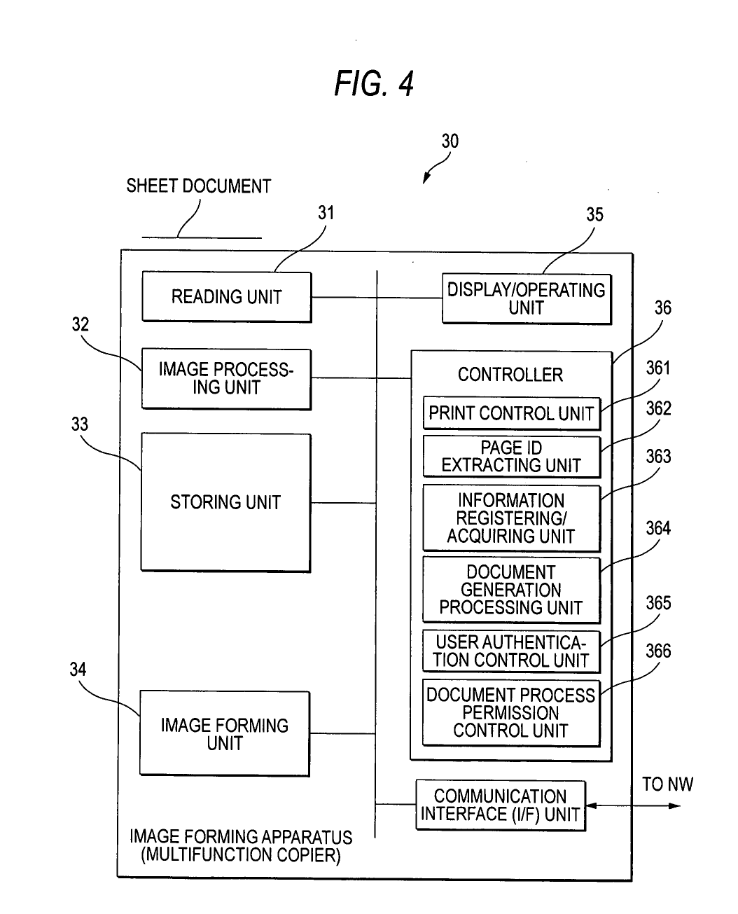

FIG. 4 is a block diagram showing a functional configuration of the image forming apparatus 30 in FIG. 1.

The image forming apparatus 30, which may be, for example, a multifunction copier having various functions such as manuscript read (scan), copy, print, facsimile (FAX) and so on, includes a reading unit (scanner) 31 that scans an image of a manuscript (sheet document) set on a platen and converts the scanned image into an electrical image signal (image data), an image processing unit 32 that performs an image process for generating print data from scan data obtained by scanning the sheet document by the reading unit 31 or from a print job sent from the client terminal 10, a storing unit 33 that stores a variety of information such as the scan data, operating programs and so on, an image forming unit 34 that forms an image corresponding to the print data on a recording medium (recording sheet) by performing an electrophotography process based on the print data generated by the image processing unit 32, a displaying/operating unit 35 such as a large bitmap display having a touch panel function, a controller 36 that performs control for all the units, including control for the units related to functions of scan, copy, print, FAX and so on, and a communication interface (I/F) unit 37 that interfaces with the client terminal 10, the user attribute information managing apparatus 40, the policy managing apparatus 50, etc. for communication therewith via the network 60, as shown in FIG. 4.

The controller 36 includes a print control unit 361 that instructs the image processing unit 32 to generate the print data based on a print job received from the client terminal 10 via the communication I/F UNIT 37 or the scan data obtained by scanning the sheet document by the reading unit 31 and instructs the image forming unit 34 to form (print) an image based on the print data on the recording sheet and output the recording sheet on which the image is formed.

Particularly, upon receiving the print job from the client terminal 10, the print control unit 361 analyzes a drawing instruction to instruct “drawing document data for pages of an electronic document by giving page IDs to corresponding pages” from the print job, gives the page IDs identifying the pages to the pages based on a result of the analysis, and controls the image forming unit 34 to print the electronic document, which is instructed to be printed, on each recording sheet corresponding to each of the pages.

In this invention, a recording sheet having an image of the document data of each page and an image of a page ID of each page formed for each page of the electronic document by the print control of the print control unit 361 is called a sheet document.

Here, if the page ID drawing instruction of the received print job instructs drawing values of the page IDs with a QR code, for example, an image corresponding to the document data of a page of the electronic document of the print source and an image of the QR code having a value of the page ID of the page are printed on the sheet document of the page.

In addition, if the page ID (image) is a recognizable (machine-readable) page ID of an image read by the reading unit 31 of the image forming apparatus 30, for example, two dimensional bar codes and information such as numbers, signs and so on may be used instead of the QR code.

In addition, the page ID may be selectively printed in any print type. For example, a page ID may be printed in any print a page ID embedded in an image area of document data of a page may be printed, or a page ID may be printed so as not to overlap with a document data image outside a document data image region, or an page ID may be printed in one or more print types.

In the following description, it is assumed that a page ID is printed using the QR code in the outside of a document data image area of a page for a sheet document of the page.

In addition, the controller 36 further includes a page ID extracting unit 362, an information registering/acquiring unit 363, a document generation processing unit 364, a user authentication control unit 365 and a document process permission control unit 366.

The page ID extracting unit 362 extracts an page ID from scan data obtained by scanning an image of a sheet document having page IDs by the reading unit 31.

The information registering/acquiring unit 363 accesses the document managing apparatus 20 based on the page ID extracted by the page ID extracting unit 362, and acquires print document attribute information (document ID, logical page number information) of an electronic document of a print source corresponding to the page ID, which is stored in the print document attribute managing table 222 of the document managing apparatus 20, electronic document data of a page corresponding to the page ID in the print source electronic document, etc. In addition, if a document file generated from the scan data is to be registered or printed, the information registering/acquiring unit 363 registers the document file or meta data related to registration of the document file.

The document generation processing unit 364 performs a sorting process of selecting or sorting scan data obtained by scanning a plurality of sheet documents by the reading unit 31 based on the document ID or logical page number information of the electronic document of the print source, which is acquired by the information registering/acquiring unit 363, and performs a process of generating a document file based on the scan data after the sorting process.

The user authentication control unit 365 acquires a user ID or password for identifying a user from the user when a sheet document is scanned, and controls user authentication based on the user ID or password in cooperation with the user attribute information managing apparatus 40, as described later.

After completion of the user authentication by the user authentication control unit 365, in cooperation with the policy managing apparatus 50, the document process permission control unit 366 inquires of the policy managing apparatus 50 about authority regarding document process (scan, copy, FAX transmission, etc.) for the scan data corresponding to the print source document having the page ID, for example, based on the page ID extracted from the scan data obtained by scanning the sheet document image by the reading unit 31 and the user ID acquired from the user in the user authentication, acquires the authority, and performs document process permission control to determine whether the document process (scan, copy, FAX transmission, etc.) is permitted or inhibited, based on the acquired authority.

Although FIG. 1 shows a system configuration in which one image forming apparatus 30 is arranged, without being limited to this, a plurality of image forming apparatuses 30 may be arranged.

In addition, from the point of view that an electronic document is printed as a sheet document with a page ID for each page of the electronic document based on a print instruction (print job) from the client terminal 10, the image forming apparatus 30 is not limited to the multifunction copier shown in FIG. 4, but one or more printers having only a print function may be also arranged.

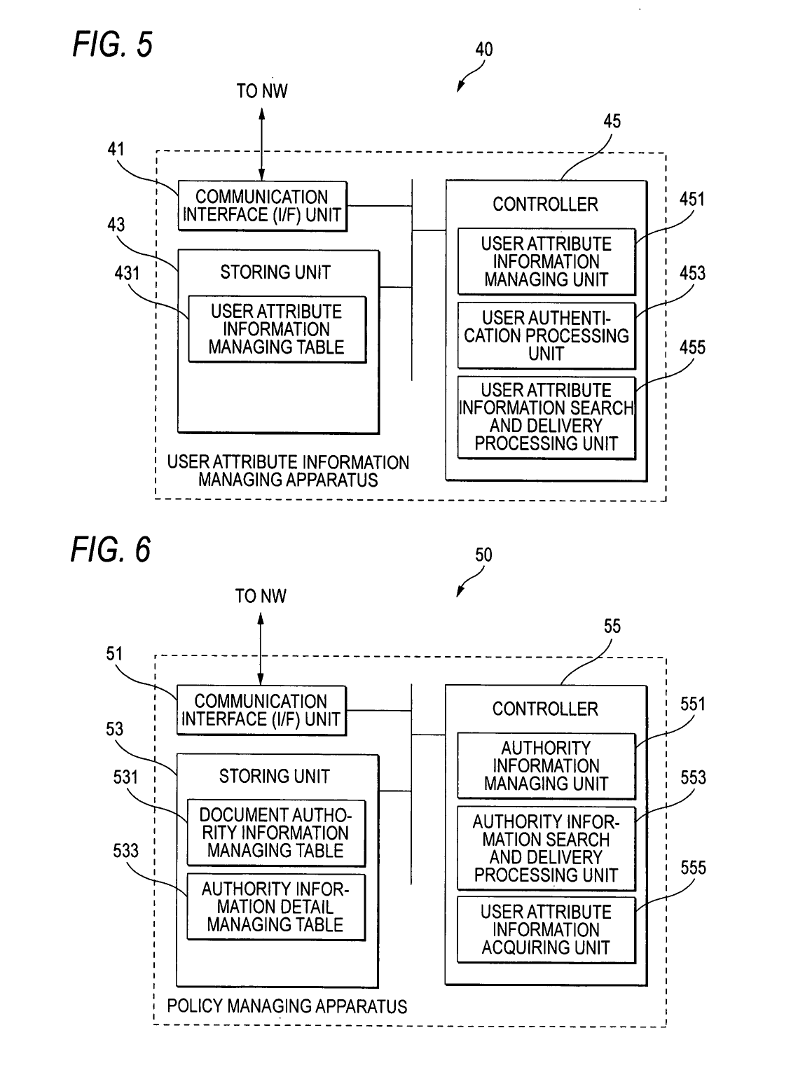

FIG. 5 is a block diagram showing a functional configuration of the user attribute information managing apparatus 40 in FIG. 1.

The user attribute information managing apparatus 40, which is realized by a general purpose computer, includes a communication interface (I/F) unit 41 that interfaces with the client terminal 10, the image forming apparatus 30, the policy managing apparatus 50, etc. for communication therewith via the network 60, a storing unit 43 that stores a variety of information such as operating programs and so on, and a controller 45 that controls the whole of the apparatus, as shown in FIG. 5.

In the user attribute information managing apparatus 40, a user attribute information managing table (TB) 431 is stored in the storing unit 43. In this embodiment, the user attribute information contains, for example, “class of position” indicating a level of authority given to a user, “post of duty” indicating a post to which a user belongs, and “point” indicating a point of a user in correspondence to “user ID” indicating information for identifying a user.

The controller 45 includes a user attribute information managing unit 451, a user authentication processing unit 453 and a user attribute information search and delivery processing unit 455.

The user attribute information managing unit 451 performs an information managing process including registration, change, deletion, and so on of user attribute information on the user attribute information managing table 431.

The user authentication processing unit 453 performs a user authenticating process of receiving a user authentication request from the client terminal 10 or the image forming apparatus 30, searching the user attribute information managing table 431 with user authentication information (user ID) and password included in the user authentication request, and sending an authentication result (authentication OK or authentication NG) indicating whether or not a user is a registered user.

The user attribute information search and delivery processing unit 455 performs a user attribute information search and delivery process of receiving a user attribute information inquiry request (the policy managing apparatus 50 operates with a document process authority inquiry request having a document ID and a user ID, as keys, from the document managing apparatus 20 requested to download a document from the client terminal 10, a document process authority inquiry request having a page ID and a user ID, as keys, extracted from scan data from the image forming apparatus 30, etc.) including the user ID from the policy managing apparatus 50, searching the attribute information (“class of position”, “post of duty” and “point”) corresponding to the user ID from the user attribute information managing table 431, and sending a result of the search to the policy managing apparatus 50.

FIG. 6 is a block diagram showing a functional configuration of the policy managing apparatus 50 in FIG. 1.

The policy managing apparatus 50, which is realized by a general purpose computer, includes a communication interface (I/F) unit 51 that interfaces with the client terminal 10, the document managing apparatus 20, the image forming apparatus 30, the user attribute information managing apparatus 40, etc. for communication therewith via the network 60, a storing unit 53 that stores a variety of information such as operating programs and soon, and a controller 55 that controls the whole of the apparatus, as shown in FIG. 6.

In the policy managing apparatus 50, a document authority information managing table (TB) 531 and an authority information detail managing table (TB) 533 are stored in the storing unit 53.

The document authority information managing table (TB) 531 contains “document ID” indicating information for identifying documents [or “page ID” indicating information for identifying pages of a document], and “operation authority” indicating a document having a document ID (or page ID) (likely, a document of a corresponding page) and an authority level of a user [an operation level permitted for “class of position” (operation level 1, 2, 3, . . . )] in correspondence to “class of position” indicating the level of authority given to the user.

The authority information detail managing table 533 contains “operation content” indicating contents of operation permitted with the authority in correspondence to “operation authority”.

For example, the authority information detail managing table 533 contains “read” of contents of permitted operation for operation level 1, “read” and “print” of contents of permitted operation for operation level 2, “read”, “scan”, “copy” and “print” of contents of permitted operation for operation level 3, and “read”, “edition”, “scan”, “copy” and “print” of contents of permitted operation for operation level 4.

By storing the document authority information and the authority information detail information having properly set values (contents) in the document authority information managing table 531 and the authority information detail managing table 533, respectively, authority management is possible in such a manner that, for example, for a document having document ID=docu001 (or a document having page ID=P0011 at a first page of a document having document ID=docu001), only read is permitted to a user whose class of position is a staff, and read and print are permitted to a user whose class of position is a manager.

In addition, the controller 55 includes an authority information managing unit 551, authority information and delivery processing unit 553 and a user attribute information acquiring unit 555.

The authority information managing unit 551 performs an information process including processes such as registration, change, deletion and so on of the document authority information and the authority detail information corresponding to the document authority information managing table 531 and the authority information detail managing table 533, respectively.

In cooperation with the document process permission control unit 146 (see FIG. 2) of the client terminal 10 or the document process permission control unit 366 (see FIG. 4) of the image forming apparatus 30, for example, the authority information and delivery processing unit 553 performs a process of receiving an authority inquiry request including a document ID and a user ID from these apparatuses, extracting the document ID and the user ID from the authority inquiry request, searching document process authority (“read”, “print”, “scan”, “copy”, “FAX transmission”, etc.) by a user having user attribute of a document corresponding to the document ID from user attribute information corresponding to the document ID and the user ID from the document authority information managing table 531 and the authority information detail managing table 533, and delivering the searched document process authority to the print apparatus.

In cooperation with the user attribute information search and delivery processing unit 455 of the user attribute information managing apparatus 40, the user attribute information acquiring unit 555 performs a control of acquiring user attribute information corresponding to the user ID (extracted from the authority inquiry request), as one search key, used by the authority information search and delivery processing unit 553 in the document process authority search from the document authority information managing table 531 and the authority information detail managing table 533 from the user attribute information managing apparatus 40.

As described above, in the policy managing apparatus 50, in cooperation with the document process permission control unit 146 (see FIG. 2) of the client terminal 10 or the document process permission control unit 366 (see FIG. 4) of the image forming apparatus 30, the authority information and delivery processing unit 553 performs the document process permission control of receiving the authority inquiry request including the document ID and the user ID from these apparatuses, and permitting or inhibiting a document process in a standpoint of the user attribute corresponding to the user ID for the document corresponding to the document ID according to a preset security policy (authority).

As an example of the document process permission control performed in cooperation with the policy managing apparatus 50, for example if the client terminal 10 tries to access a protective document (a document to which authority (security policy) is set) managed by the document managing apparatus 20, the client terminal 10 starts to execute an application by operation of a user to open a protective document file to which security policy is set.

At this time, the client terminal 10 acquires a user ID by causing the user to perform user authentication according to a predetermined method, and thereafter, the document process permission control unit 146 extracts a document ID added to the protective document file (which was coded) and sends the document ID and the user ID to the policy managing apparatus 50.

In the mean time, when the policy managing apparatus 50 receives the document ID and the user ID, the authority information search and delivery processing unit 553 examines an operation level set to the user corresponding to the received document ID from the document authority information managing table 531, examines authority set to the user from the authority information detail managing table 533 based on the operation level, and informs the document process permission control unit 146 of the client terminal 10 of results of the examination.

On the other hand, in the client terminal 10, the document process permission control unit 146 determines based on the authority sent from the policy managing apparatus 50 whether or not the user has right to read the document, and, if it is determined that the user has the right to read the document, decodes the protective document file using a decode key sent along with the authority from the policy managing apparatus 50 and displays the decoded protective document file on a screen.

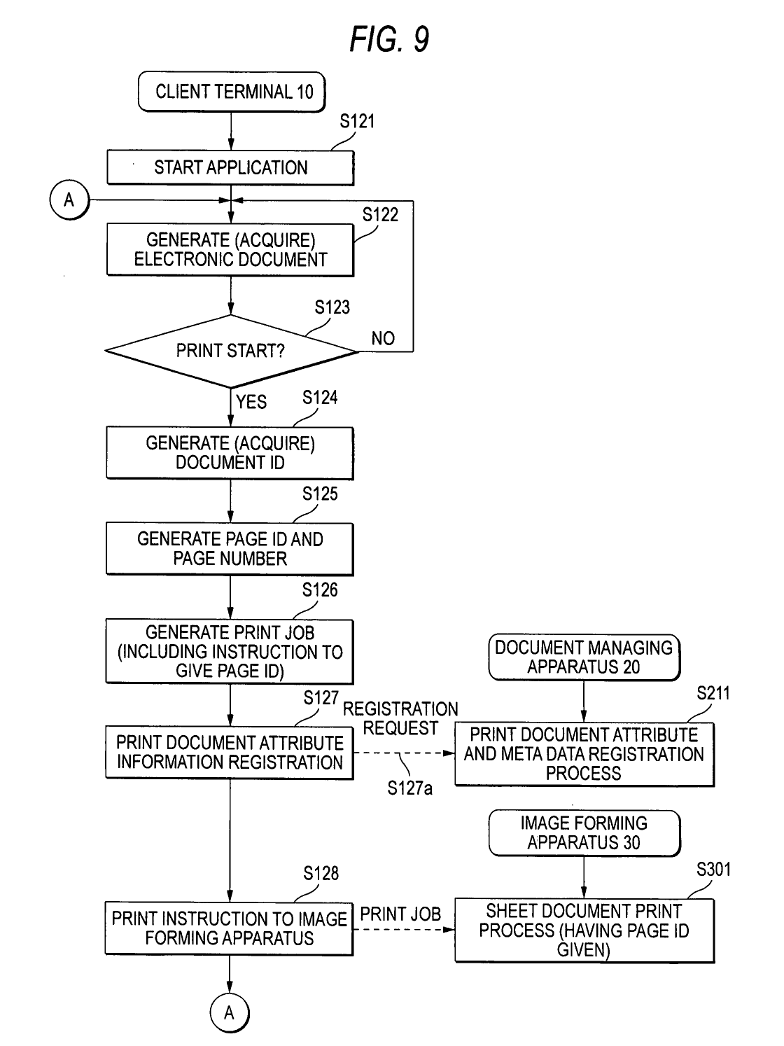

Thereafter, if the displayed electronic document (protective document) is to be printed (see a control sequence shown in FIG. 9), the client terminal 10 inquires of the policy managing apparatus 50 about the authority with a document ID of the electronic document as a key, confirms that the electronic document is permitted to be printed by referring to the authority sent from the policy managing apparatus 50, sends a print instruction (print job) to the image forming apparatus 30, and prints a sheet document having a page ID.

In addition, as an example of the document process permission control performed in cooperation with the policy managing apparatus 50, the document process permission control unit 366 of the image forming apparatus (multifunction copier) 30 performs the following control when the reading unit 31 scans a sheet document.

Here, it is assumed that an image corresponding to an electronic document of pages of the sheet document to be scanned and an image of page IDs identifying the pages are printed on a recording sheet by the image forming apparatus 30 such as a multifunction copier or a printer, based on a print instruction from the client terminal 10.

In the image forming apparatus 30, when the page ID extracting unit 362 extracts a page ID from scan data obtained by scanning a sheet document in the reading unit 31 after determination of user authentication OK by the user authentication process function, the document process permission control unit 366 inquires of the document managing apparatus 20 about a document ID based on the extracted page ID, acquires a document ID of a document of a print source, which is stored in the print document attribute managing table 222 in correspondence to the page ID, and sends an authority acquisition request including the acquired document ID and a user ID, which is acquired from a user in the user authentication process, to the policy managing apparatus 50.

When the policy managing apparatus 50 receives the authority acquisition request, the authority information search and delivery processing unit 553 examines an operation level corresponding to the user ID and the document ID included in the received authority acquisition request from the document authority information managing table 531, examines authority from the authority information detail managing table 533 based on the operation level, and informs the image forming apparatus 30 of results of the examination.

In the image forming apparatus 30, the document process permission control unit 366 examines based on the authority sent from the policy managing apparatus 50 whether or not the user has authority of document process (scan, copy, FAX transmission, etc.) corresponding to user operation (initiation instruction operation of scan, copy, FAX transmission, etc.) which is the cause of scan, and instructs the document generation processing unit 364 to perform the document process, for example, based on the scan data.

Here, from the fact that the sheet document treated in this system has page IDs corresponding to pages of the sheet document, if the reading unit 31 is to read a plurality of sheet documents, sheet documents with different electronic document as a derivative source may be mixed, or sheet documents with the same electronic document as a derivative source may be read with their page order changed.

Even in this case, in the present invention, when the image forming apparatus 30 is used, without having a user aware of reading operation of document unit or page order of a plurality of sheet documents having page IDs, a document having scan data of pages, which are obtained by scanning the plurality of sheet documents, the scan data and are collected in document unit or page order of an electronic document of a print source, is generated to give a convenience to a user who uses a derivative document generated based on the scan data.

Hereinafter, a document generation processing function in the image forming apparatus 30 of the invention will be described in detail through exemplary embodiments.

### FIRST EMBODIMENT

In a first embodiment of the invention, the client terminal 10, the document managing apparatus 20, the image forming apparatus 30, the user attribute information managing apparatus 40 and the policy managing apparatus 50 of the system shown in FIG. 1 are constituted as functional blocks shown in FIGS. 2, 3, 4, 5 and 6, respectively.

In the system of this embodiment, when the image forming apparatus 30 prints an electronic document as a sheet document having page IDs, the document managing apparatus 20 manages print document attribute information including a document ID, page IDs of pages, logical page numbers, etc. of the electronic document of the print source, while the image forming apparatus 30 extracts page IDs from scan data obtained by scanning a plurality of sheet documents, acquires an document ID of the print document attribute information of the electronic document of the print source corresponding to the page IDs from the document managing apparatus 20, and selects the scan data, with the acquired document ID as a key, to generate one document file.

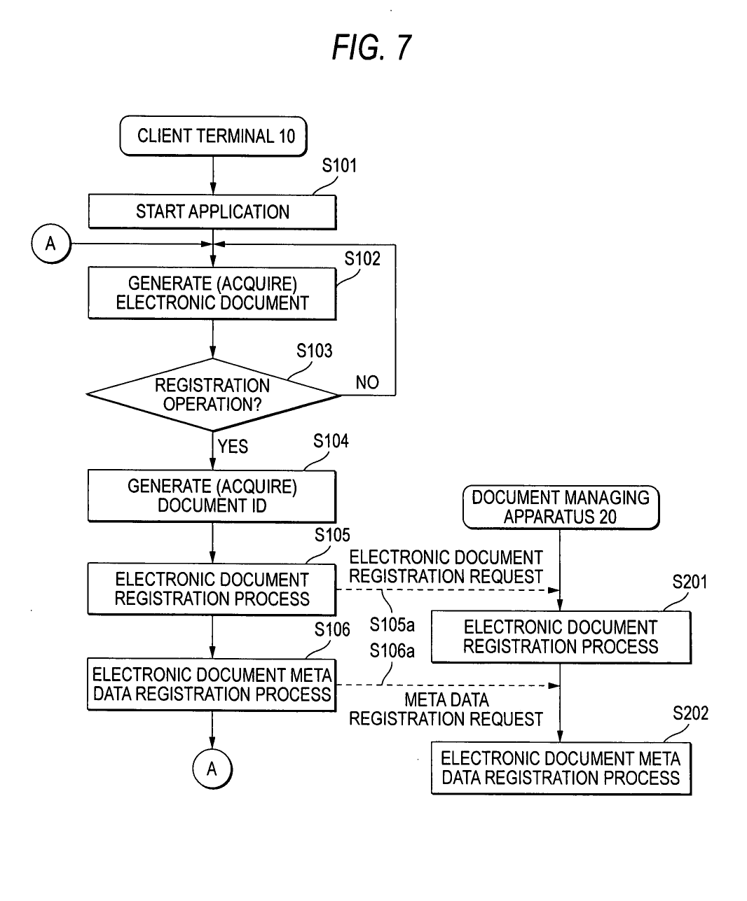

The control of the electronic document and the document attribute information in the document managing apparatus 20 is realized through the document registering process (see FIG. 7) from the client terminal 10 into the document managing apparatus 20 and the document printing process (see FIG. 9) in the image forming apparatus based on a print instruction from the client terminal 10, which will be described later.

FIG. 7 is a view showing a control sequence between the client terminal 10 and the document managing apparatus 20, which is related to a document registering process in the system according to the first embodiment.

In the document registering process shown in FIG. 7, based on a user operation in the input/operation unit 11, the client terminal 10 instructs the application unit 141 to start an application (document processing application) (Step S101), displays an edition screen to receive input information, and generates electronic document data based on the input information (Step S102).

In the electronic document data generating process, the document attribute information generating unit 144 checks whether or not a user performs a document registering operation through the input/operation unit 11 (Step S103), and, if it is checked that the user performs the document registering operation (YES in Step S103), generates an document ID identifying the electronic document data by, for example, having the user input a desired document ID through a registration setting screen (Step S104).

In addition, for example, if a process of acquiring electronic document data pre-registered in the document managing apparatus 20 or the like is permitted and the electronic document data are acquired from a registration site in Step S102, a document ID of the electronic document data may be acquired from the registration site in Step 104.

After the generation of the electronic document data in Step S102 (or after acquiring a document from the document managing apparatus 20 and completing edition of the document), if the registration operation is performed in Step S103 (YES in Step S103), the information registering/acquiring unit 142 sequentially performs a process of registering the electronic document data generated (or acquired) in Step S102 (Step S105) and a process of registering various data (meta data related to the registration of the electronic document data) including the document ID generated (or acquired) in Step S104 (Step S106).

When the electronic document data are registered in Step S105, the information registering/acquiring unit 142 sends a registration request including the electronic document data to the document managing apparatus 20 (Step S105a).

In the mean time, in the document managing apparatus 20, when the process request receiving unit 241 receives the electronic document registration request sent from the client terminal 10, the information managing unit 242 stores the electronic document data included in the registration request in, for example, a predetermined storing site of the storing device 23 (Step S201: electronic document registering process).

In addition, when the electronic document meta data are registered in Step S106, the information registering/acquiring unit 142 sends a registration request including the document ID generated by the document attribute information generating unit 144 when the electronic document data are generated and various meta data related to the document registration to the document managing apparatus 20 (Step S106a).

In the mean time, in the document managing apparatus 20, when the process request receiving unit 241 receives the electronic document meta data registration request sent from the client terminal 10, the information managing unit 242 stores the document ID included in the registration request and a corresponding storing site of the electronic document data in Step S201 in, for example, the registration document attribute managing table 221 of the storing unit 22 (Step S202: electronic document meta data registering process).

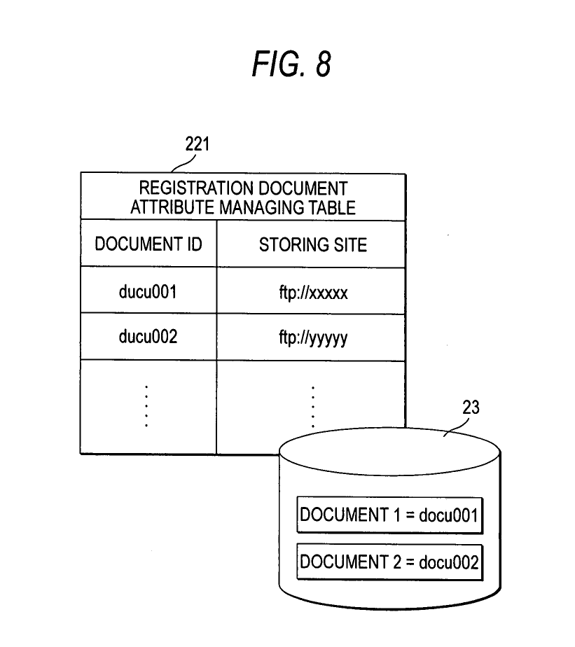

FIG. 8 is a table diagram showing an example of information registered in the registration document attribute managing table 221 of the document managing apparatus 20.

In this example, the registration document attribute managing table 221 contains a document ID (=docu1) of document 1 stored in the storing device 23 and a storing site (=ftp://xxxxx) of the document 1 in the storing device 23, and a document ID (=docu2) of document 2 stored in the storing device 23 and a storing site (=ftp://yyyyy) of the document 2 in the storing device 23 in respective correspondence therebetween.

Also, although the example of FIG. 8 shows that the registration document attribute managing table 221 contains only the document IDs and the corresponding storing sites of the electronic document data having the document IDs, meta data such as a creator, creation date and so on of the electronic document data may be additionally stored in the registration document attribute managing table 221.

FIG. 9 is a view showing a control sequence between the client terminal 10, the document managing apparatus 20 and the image forming apparatus 30, which is related to an electronic document printing process according to the first embodiment.

In the electronic document printing process shown in FIG. 9, for example, the client terminal 10 starts an application by the same process as Step S101 of FIG. 7 (Step S121), and generates or acquires electronic document data by the same process as Step S102 of FIG. 7 (Step S122).

In the electronic document data generating process, the document attribute information generating unit 144 checks whether or not a user performs a print starting operation through the input/operation unit 11 (Step S123), and, if it is checked that the user performs the print starting operation (YES in Step S123), generates an document ID identifying the electronic document (electronic document of a print source) (Step S124).

The document ID of the print source electronic document can be generated by the same process as Step S104 of FIG. 7, and also acquired if the electronic document data are acquired from a registration site.

Subsequently, the document attribute information generating unit 144 analyzes the print source electronic document data and generates logical page numbers of pages of the electronic document data and page IDs of the pages (Step S125).

For the page IDs, for example, Hash values are calculated based on the electronic document data of the pages of the print source electronic document, and the calculated Hash values are generated as page IDs of the pages.

Subsequently, the print job generating unit 143 generates a print job from the electronic document data generated (or acquired) in Step S122 and the page IDs generated in Step S125 (Step S126).

Here, the print job generating unit 143 generates a print job describing a drawing instruction to draw the electronic document data of the pages of the print source by giving the pages the corresponding page IDs, more specifically, an instruction to draw the electronic document data of the pages and a QR code corresponding to Hash values calculated as the page IDs based on the electronic document data of the pages.

After generating the print job, the information registering/acquiring unit 142 registers the document ID of the print source electronic document generated (or acquired) in Step S124 and the logical page numbers and page IDs of the pages generated in Step S125 in correspondence therebetween (Step S127).

In the print document attribute information registering process, the information registering/acquiring unit 142 sends a registration request including the document ID of the print source electronic document and the logical page numbers and page IDs of the pages of the print source electronic document (Step S127a).

In the mean time, in the document managing apparatus 20, when the process request receiving unit 241 receives the print document attribute registration request sent from the client terminal 10, the information managing unit 242 extracts the document ID, the logical page numbers and page IDs of the pages, and page size included in the registration request individually, and stores the extracted information in, for example, the print document attribute managing table 222 of the storing unit 22 in correspondence therebetween (Step S211: print document attribute and meta data registraton process).

Thereafter, the print job generating unit 143 performs a print instruction process to send the print job generated in Step S126 to the image forming apparatus 30 via the communication I/F unit 15 and the network 60 (Step S128).

On the other hand, when the image forming apparatus 30 receives the print job sent from the client terminal 10 via the communication I/F unit 37, the print control unit 361 performs a sheet document printing process based on the print job (Step S301).

In the sheet document printing process, the print control unit 361 analyzes the drawing instruction of the received print job, and, based on a result of the analysis, instructs the image processing unit 32 to generate print image data to draw the electronic document data and the QR code representing the page IDs corresponding to the pages, and instructs the image forming unit 34 to print the pages as sheet documents of numbers corresponding to the number of pages on which images of the electronic document data of the pages and QR code images corresponding to the page IDs of the pages are formed, based on the print image data.

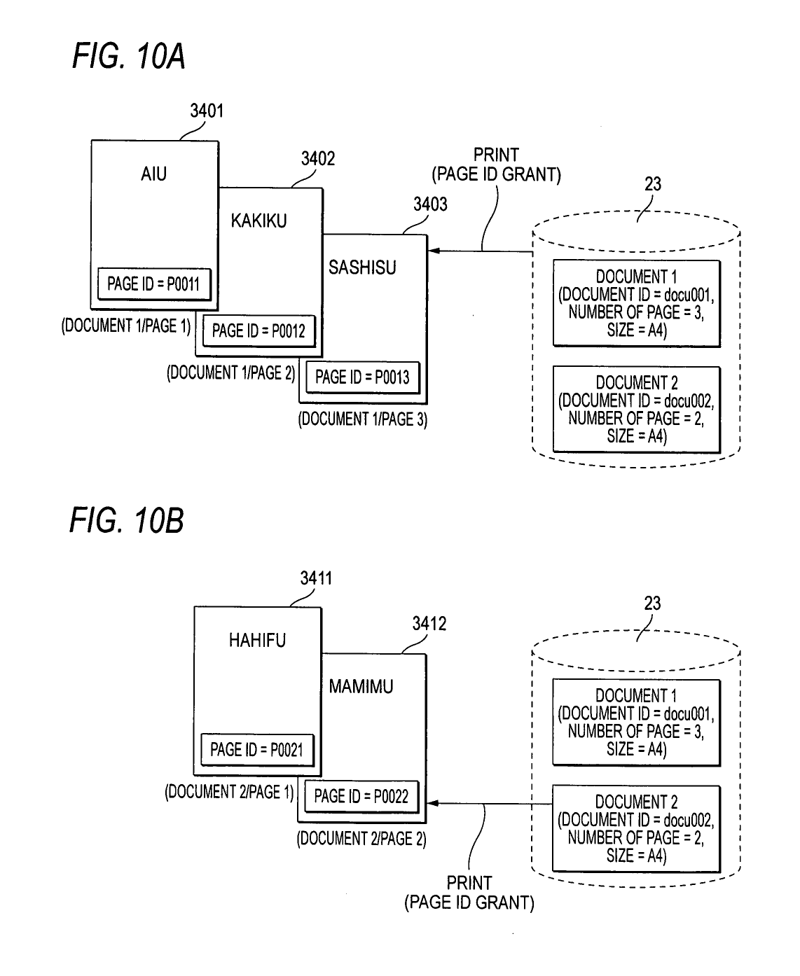

FIG. 10 is a conceptual view showing an example of a sheet document print output by the image forming apparatus 30 in Step S301 of FIG. 9.

In FIG. 10, (a) shows an example of an output of document 1 which has a document ID “docu001” and is composed of three A4-size pages, and (b) shows an example of an output of document 2 which has a document ID “docu002” and is composed of two A4-size pages.

When a user instructs the client terminal 10 to print document 1 as shown in FIG. 10(a), the image forming apparatus 30 that receives a print job based on the print instruction, first, outputs a sheet document 3401 of a first page on which an image ( [symbol] (a i u)) corresponding to electronic document data of the first page and an image corresponding to a page ID (=P0011) corresponding to the first page are formed, subsequently, outputs a sheet document 3402 of a second page on which an image ( [symbol] (ka ki ku)) corresponding to electronic document data of the second page and an image corresponding to a page ID (=P0012) corresponding to the second page are formed, and, finally, outputs a sheet document 3403 of a third page on which an image ( [symbol] (sa si su)) corresponding to electronic document data of the third page and an image corresponding to a page ID (=P0013) corresponding to the third page are formed, and then, the print operation is ended.

In addition, when a user instructs the client terminal 10 to print document 2 as shown in FIG. 10(b), the image forming apparatus 30 that receives a print job based on the print instruction, first, outputs a sheet document 3411 of a first page on which an image ( [symbol] (ha hi hu)) corresponding to electronic document data of the first page and an image corresponding to a page ID (=P0021) corresponding to the first page are formed, and, subsequently, outputs a sheet document 3412 of a second page on which an image ( [symbol] (ma mi mu)) corresponding to electronic document data of the second page and an image corresponding to a page ID (=P0022) corresponding to the second page are formed, and then, the print operation is ended.

When the image forming apparatus 30 prints and outputs document 1 and document 2 as sheet documents having the page IDs of the pages according to the print instruction from the client terminal 10, as shown in FIG. 10, print document attribute information on documents 1 and 2 is stored in the print document attribute managing table 222 of the document managing apparatus 20 by the print document attribute and meta data registration process in Step S211 of FIG. 9.

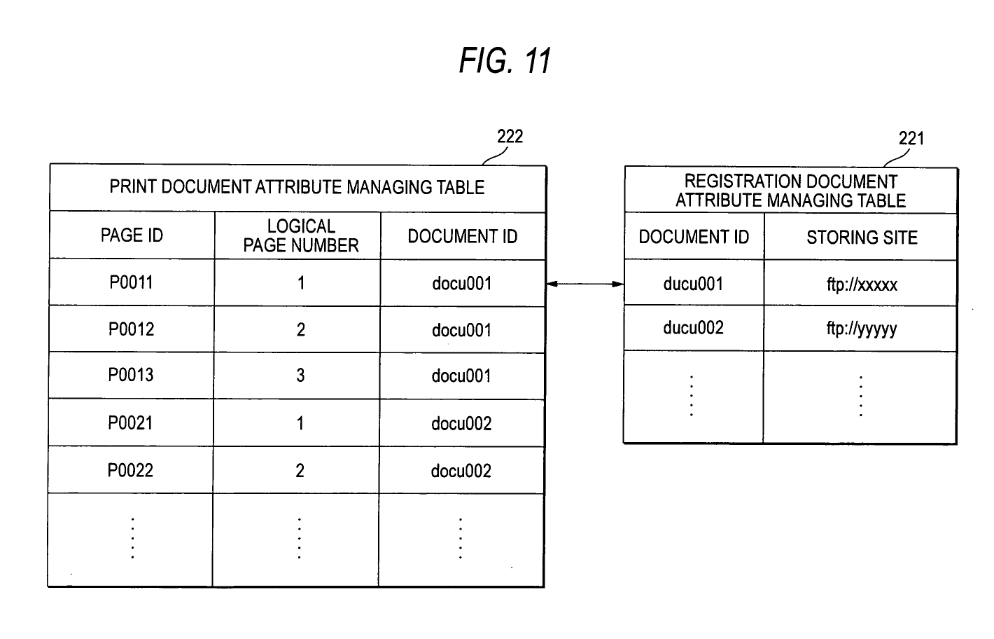

FIG. 11 is a table diagram showing an example of information stored in the print document attribute managing table 222 of the document managing apparatus 20.

As shown in FIG. 11, when electronic document 1 is printed, the page IDs (P0011, P0012 and P0013) of the respective first to third pages of document 1 and logical page numbers (1, 2 and 3) of the pages are stored in correspondence to the document ID (docu001) of electronic document 1 of the print source.

Likely, when electronic document 2 is printed, the page IDs (P0021 and P0022) of the respective first and second pages of document 2 and logical page numbers (1 and 2) of the pages are stored in correspondence to the document ID (docu002) of electronic document 2 of the print source.

Here, the document IDs stored in the print document attribute managing table 222 is linked with the document IDs stored in the registration document attribute managing table 221, and accordingly, if the page IDs stored in the print document attribute managing table 222 are known, storing sites of the electronic document data of the print source corresponding to the document IDs can be known through a linkage from the document IDs of the print document attribute managing table 222 corresponding to the page IDs to the document IDs having the same value of the registration document attribute managing table 222.

Next, a process when the sheet document printed as shown in FIG. 10 is scanned by the image forming apparatus 30 will be described.

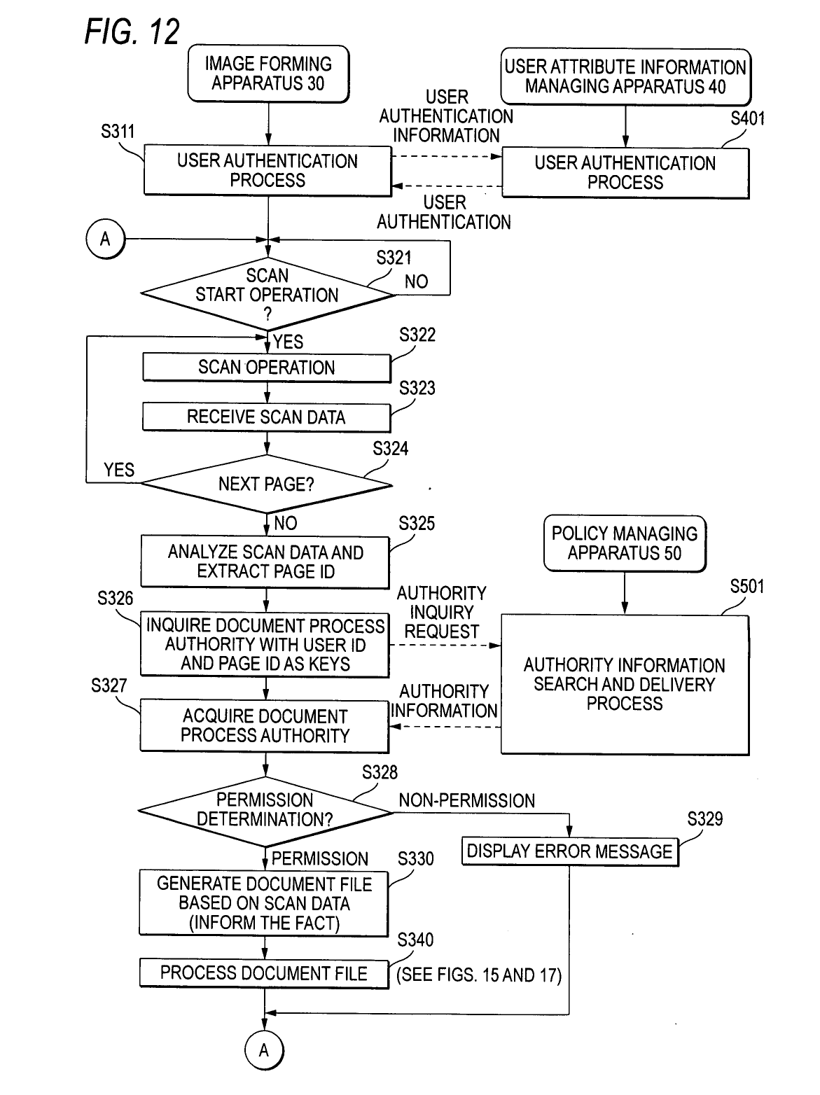

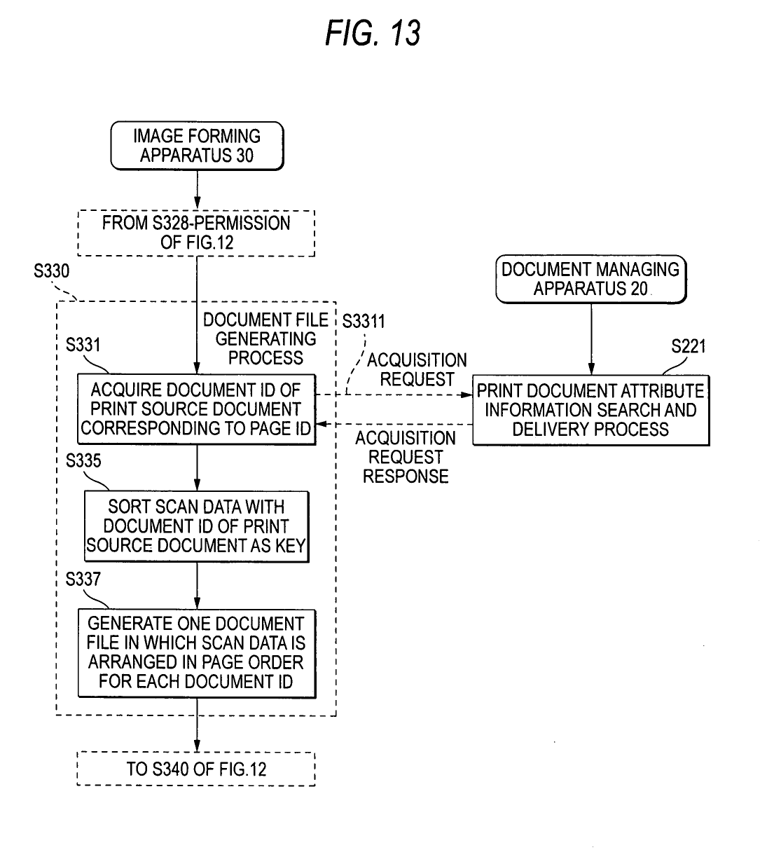

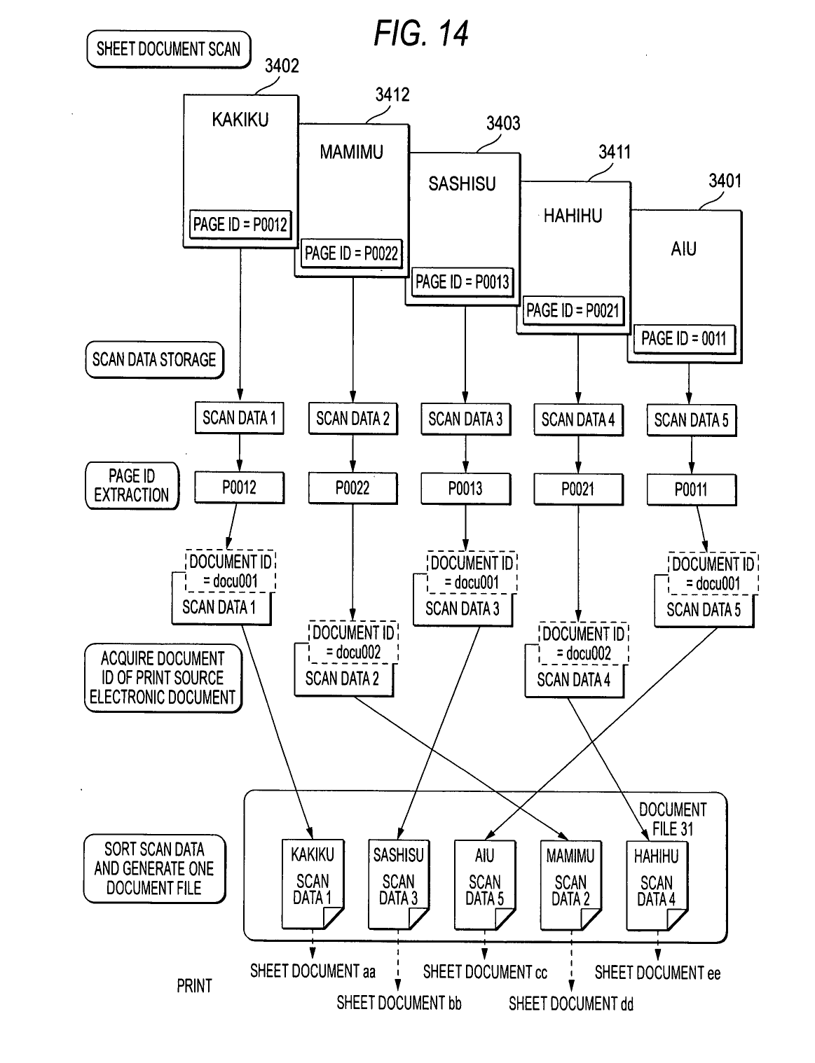

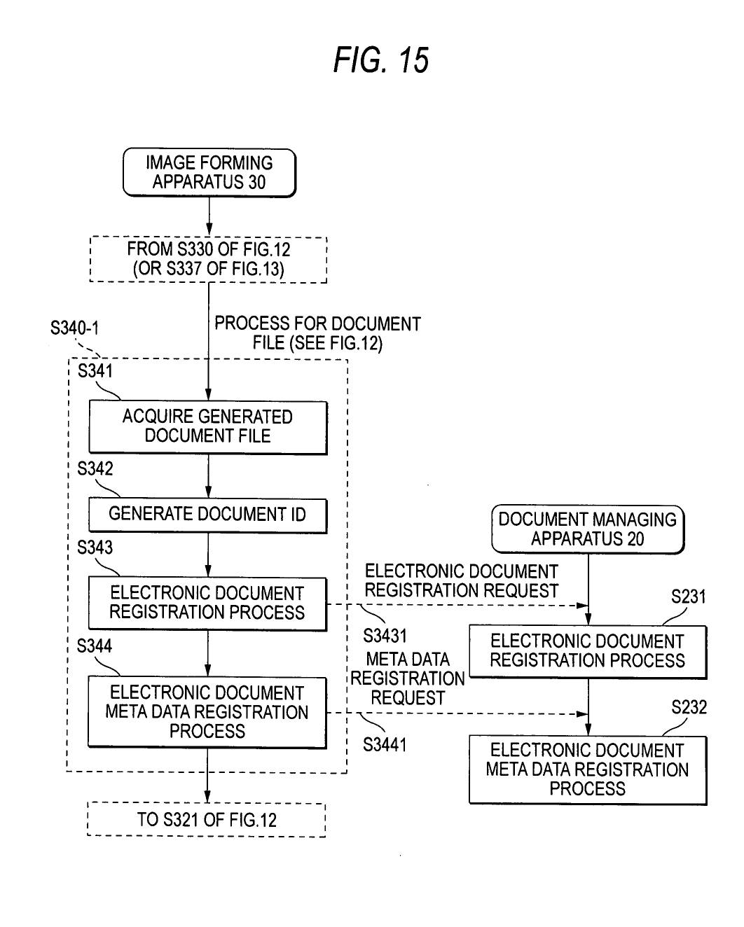

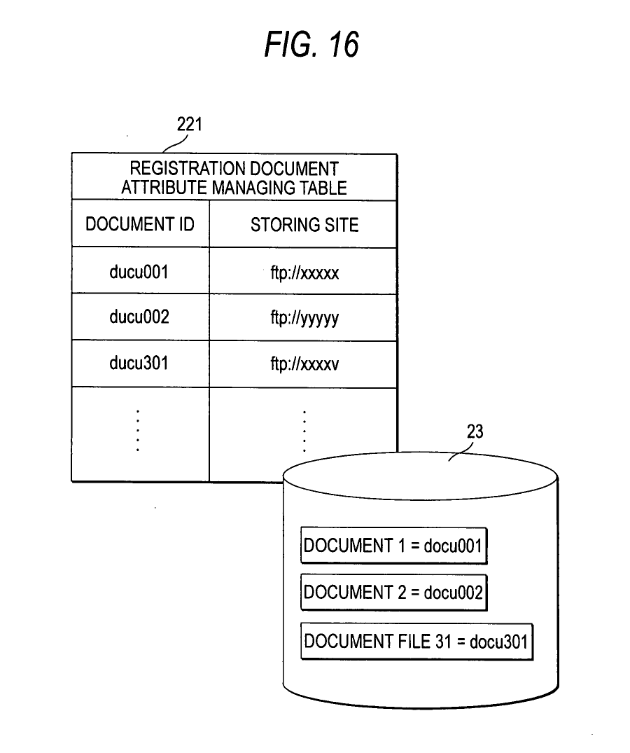

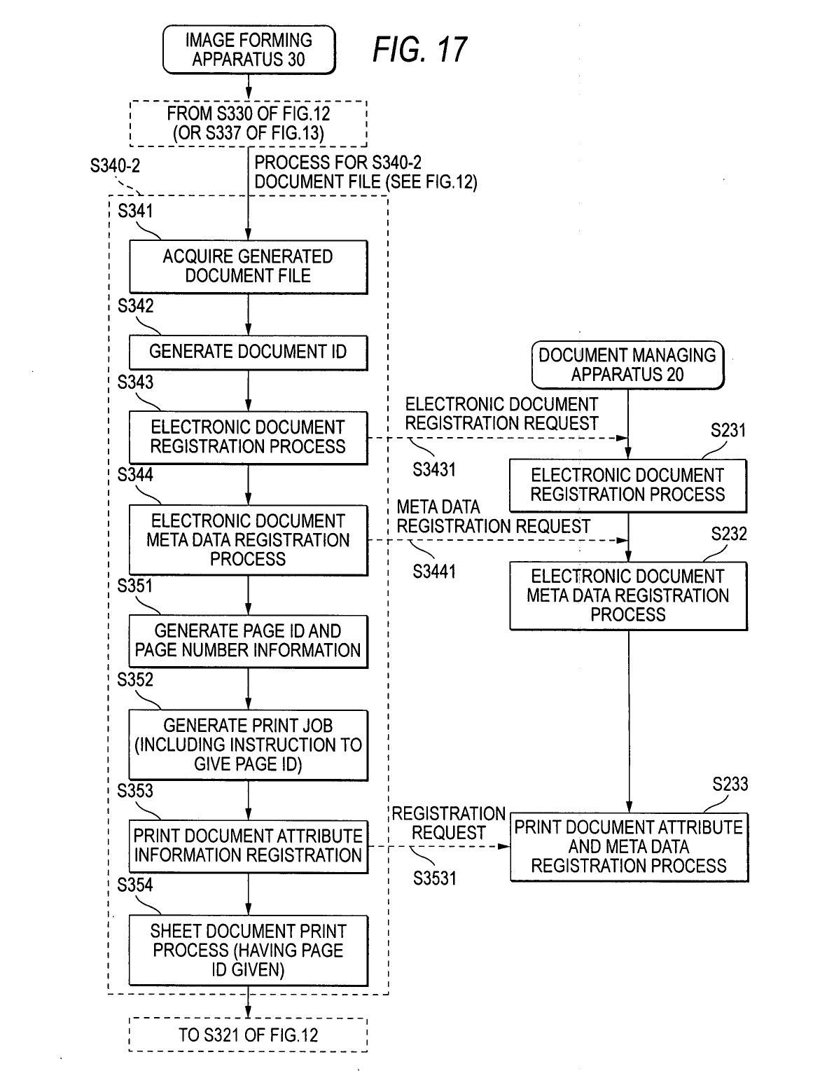

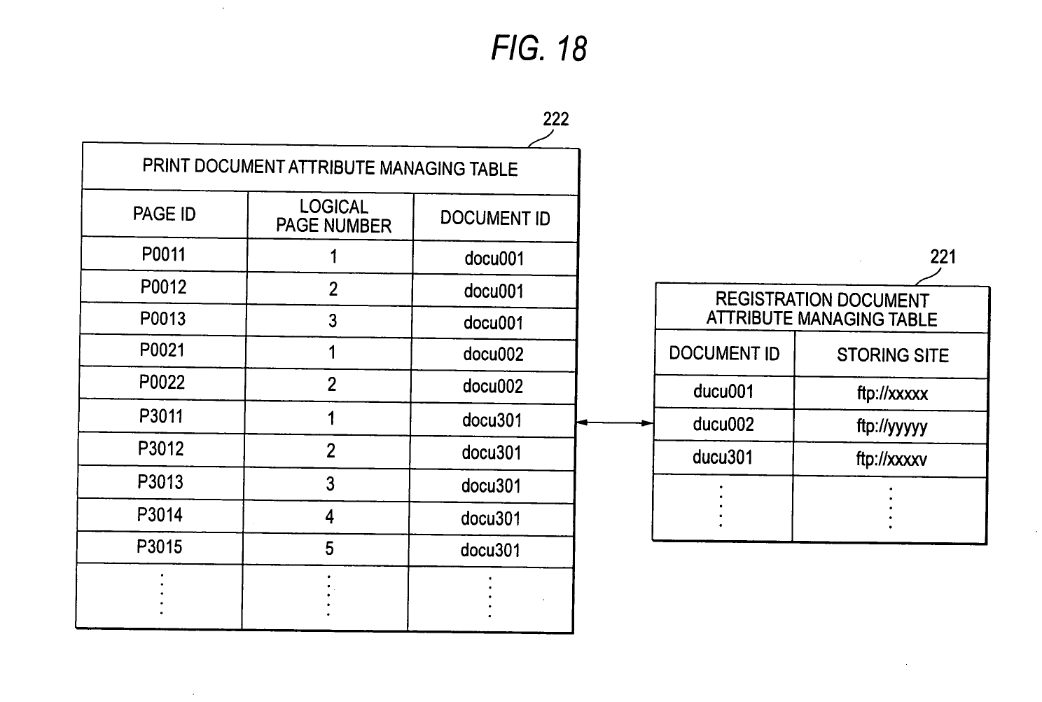

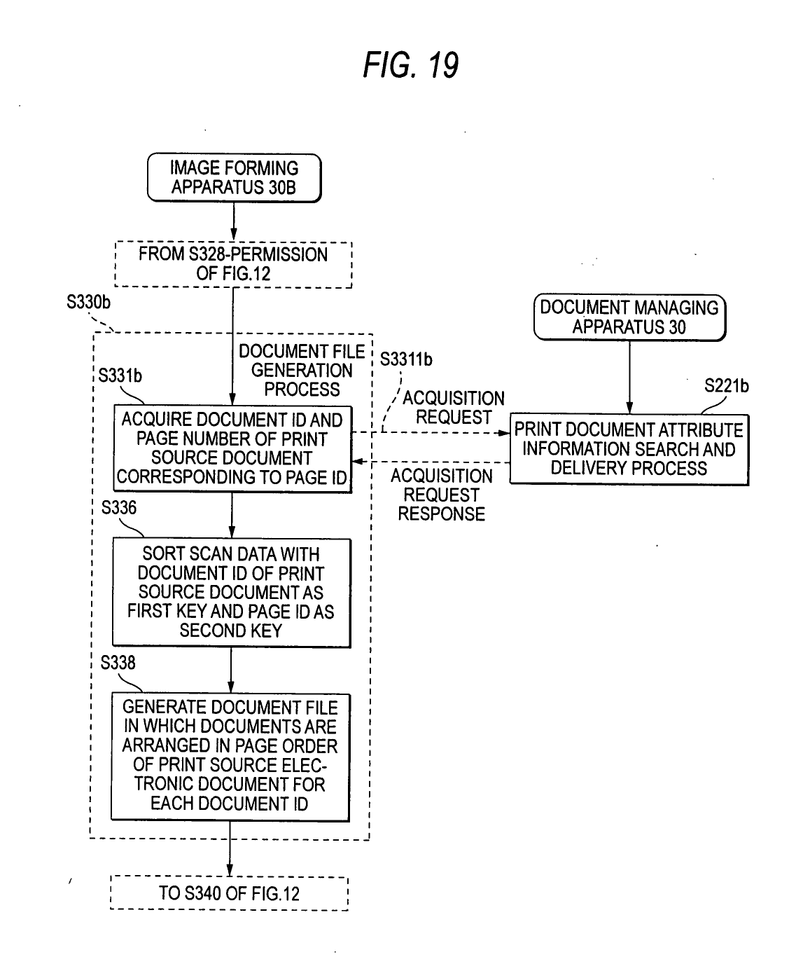

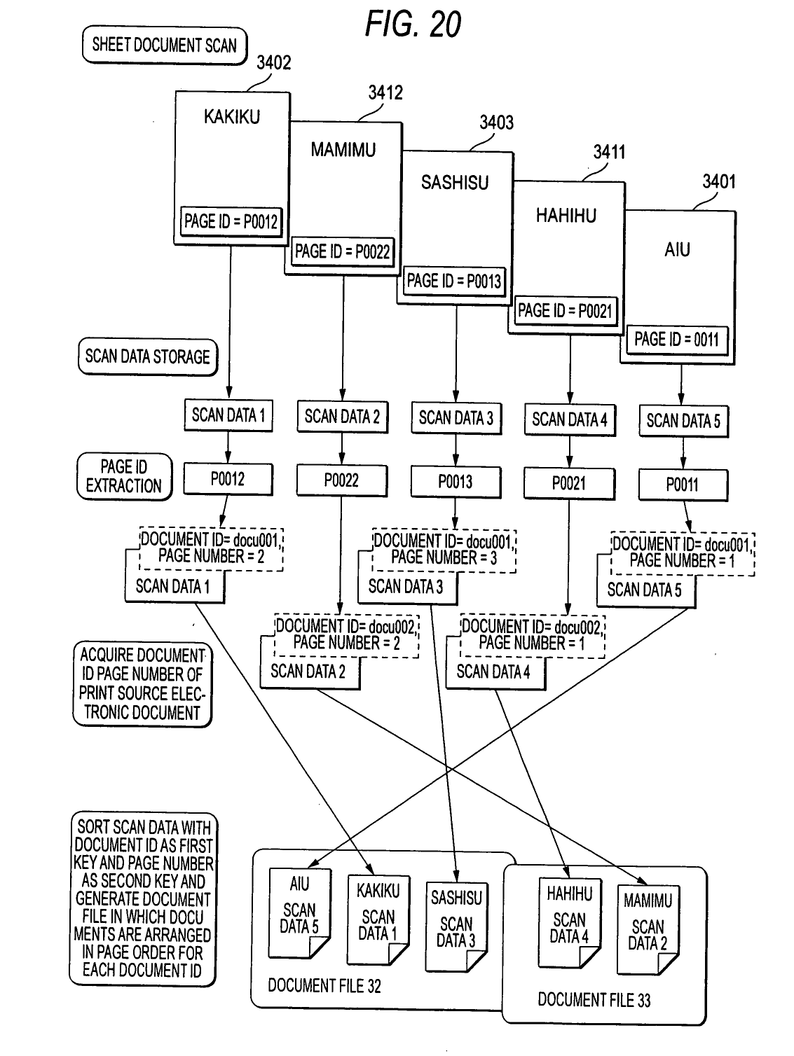

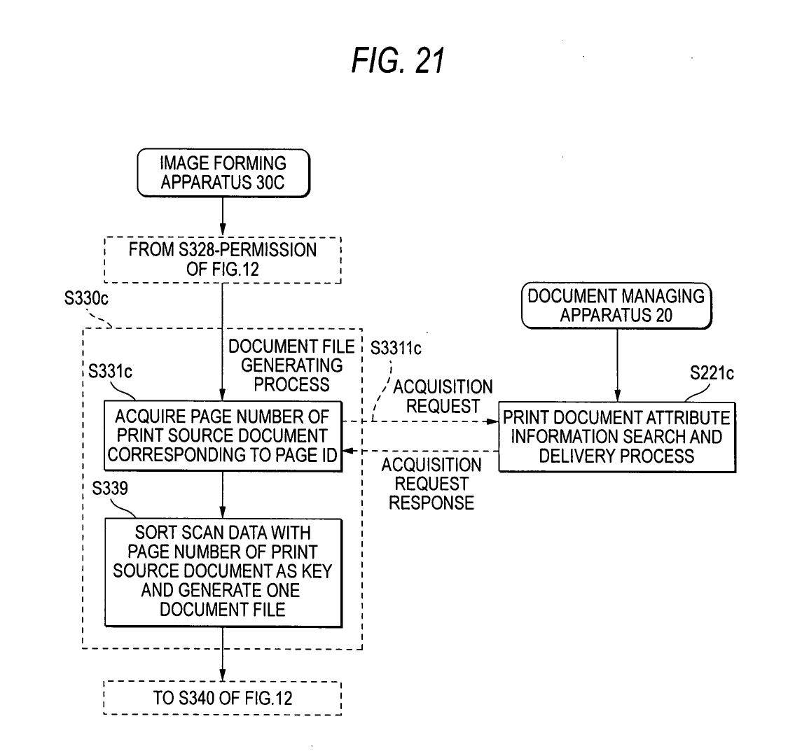

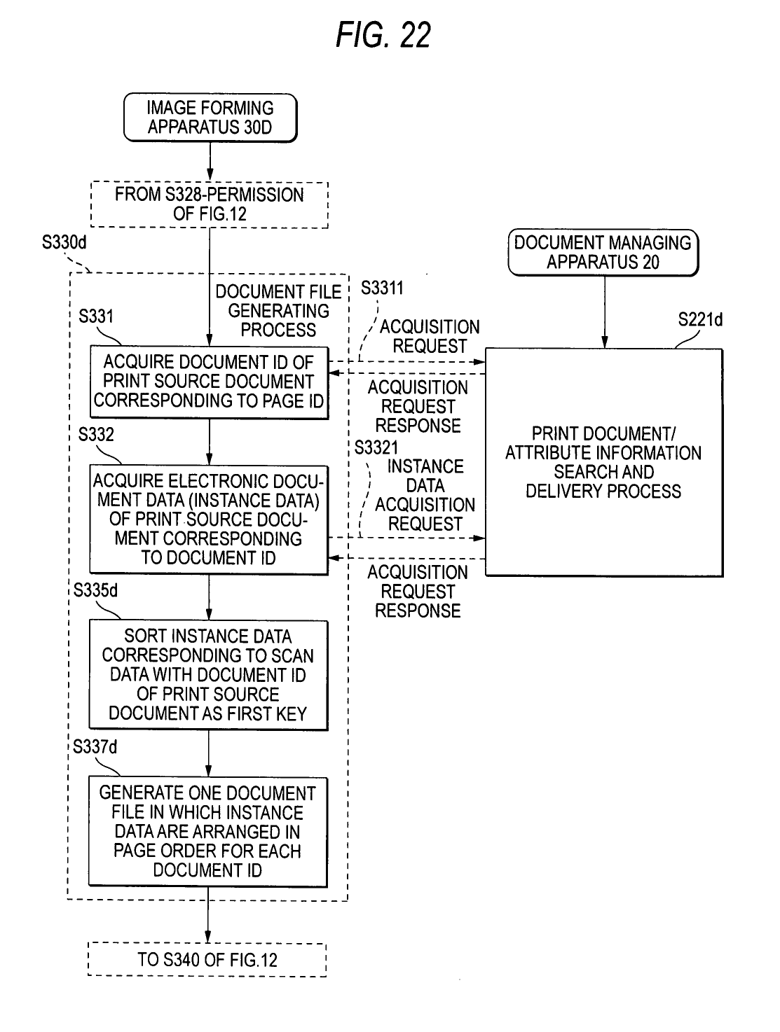

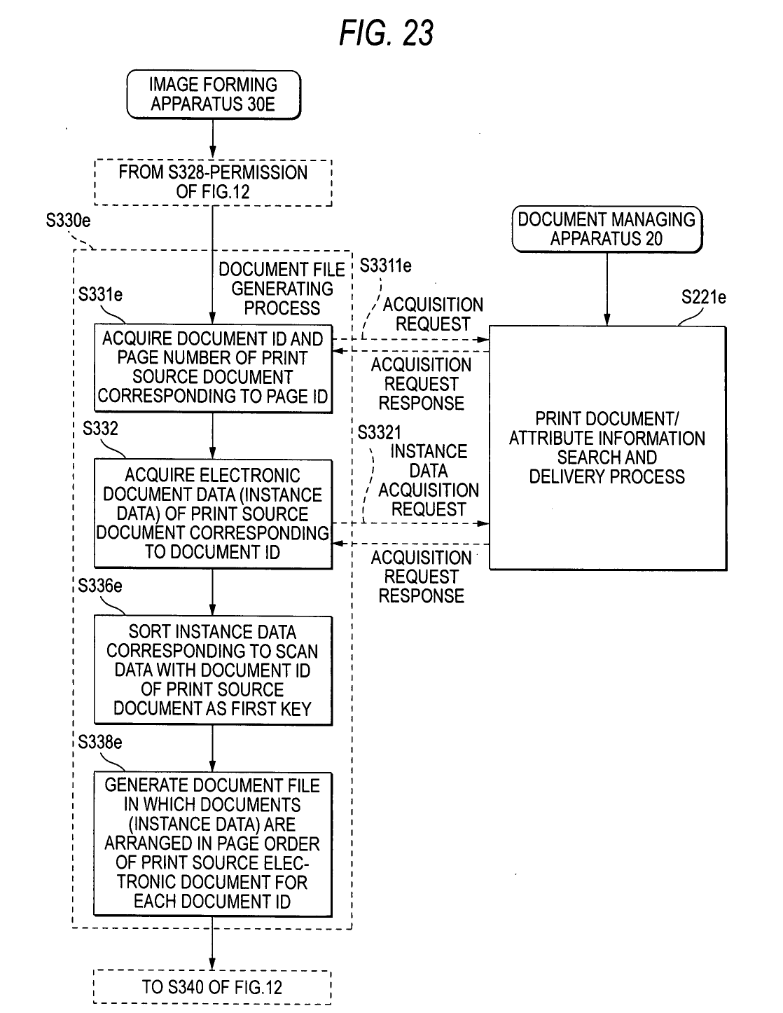

FIG. 12 is a view showing a control sequence between the user attribute information managing apparatus 40 and the policy managing apparatus 50, which is related to the sheet document scanning process in the image forming apparatus 30 according to the first embodiment.

In the image forming apparatus 30, when a sheet document is scanned, first, a user needs to perform a user authentication operation.

In order to receive the user authentication operation, for example, the user authentication control unit 365 displays an operation guidance, which urges the user to input a user ID and password, on the displaying/operating unit 35, and performs the user authentication process based on the user ID and password inputted by the user according to the operation guidance (Step S311).

In the user authentication process, the user authentication control unit 365 sends a user authentication request including the user ID and password (user authentication information) inputted by the user to the user attribute information managing apparatus 40.

On the other hand, in the user attribute information managing apparatus 40, the user authentication processing unit 453 performs the user authentication process based on a user authentication request sent from the image forming apparatus 30 (Step S401).

In the user authentication process, the user authentication processing unit 453 extracts the user ID and password included in the user authentication request received from the image forming apparatus 30, searches the user attribute information managing table 431 with the user ID as a key, determines whether the user authentication is OK or NG depending on whether or not the user ID is registered and a password registered corresponding to the user ID matches the received password, and sends a result of the determination to the image forming apparatus 30.

In the mean time, when the image forming apparatus 30 receives the user authentication determination result sent from the user attribute information managing apparatus 40, the user authentication control unit 365 determines whether the received determination result is user authentication OK or user authentication NG, and, if it is determined that the received determination result is user authentication OK, performs control operation so that start operation of various functions by the user can be received.

Here, if a plurality of sheet documents is to be scanned, the user sets the plurality of sheet documents on, for example, a sheet feeder, and then performs scan start operation using the displaying/operating unit 35.

Although it is exemplified in this embodiment that the plurality of sheet documents are set on the sheet feeder, fed automatically, and scanned sequentially, the user may manually set the sheet documents in order one by one to have the sheet document scanned sequentially.

In the mean time, in the image forming apparatus 30, after the user authentication, the controller 36 checks whether or not the scan start operation is performed (Step S321), and, if it is checked that the scan start operation is performed (YES in Step S321), drives the sheet feeder to forward a first sheet document up to a read position on a platen. Subsequently, the controller 36 drives the reading unit 31 to scan an image of the sheet document set on the platen (Step S322), and temporarily stores scan data obtained by the scan operation in, for example, the storing unit 33 (Step S323).

Every time the scan operation for one sheet document is completed, the controller 36 checks whether or not there exists a next sheet document (next page) (Step S324), and, if it is checked that there exists the next sheet document (YES in Step S324), continues to perform the scan operation for the next sheet document (Steps S322 and S323).

On the other hand, if it is checked that there exists no next sheet document (NO in Step S324), the controller 36 informs the page ID extracting unit 362 that the scan operation is ended.

Then, the page ID extracting unit 362 starts a process of extracting page IDs for scan data corresponding to the sheet documents, which are obtained by the scan operation by that time, based on scan data corresponding to page IDs of the scan data (Step S325).

After the page ID extracting process by the page ID extracting unit 362 is completed, the document process permission control unit 366 performs a process of inquiring of the policy managing apparatus 50 about document process authority for the scan data (Step S326).

In this process, the document process permission control unit 366 sends a document process authority inquiry request including the page IDs extracted from the scan data corresponding to the sheet documents in Step S325 and the user ID acquired from the user in the user authentication process of Step S311 to the policy managing apparatus 50 (Step S326).

In the mean time, in the policy managing apparatus 50, the authority information search and delivery processing unit 553 receives the document process authority inquiry request sent from the image forming apparatus 30 via the communication I/F unit 51 and performs a authority information search and delivery process (Step S501).

In the authority information search and delivery process, first, the authority information search and delivery processing unit 553 extracts the user ID and page IDs included in the received document process authority inquiry request.

Subsequently, the authority information search and delivery processing unit 553 sends a user attribute information acquisition request including the extracted user ID to the user attribute information managing apparatus 40 to acquire user attribute information [information of the above-mentioned authority level “=class of position” or the like] corresponding to the user ID, while sending a document attribute information acquisition request including the page IDs extracted along with the user ID to the document managing apparatus 20 to acquire a document ID of an electronic document of a print source corresponding to the page IDs.

In addition, the authority information search and delivery processing unit 553 examines an operation level corresponding to the acquired user attribute information and document ID from the document authority information managing table 531, examines authority information [representing permitted operation contents (“read”, “scan”, “copy”, “print”, etc.)] corresponding to the operation level from the authority information detail managing table 533, and informs the image forming apparatus 30 of results of the examination.

In the mean time, in the image forming apparatus 30, the document process permission control unit 366 receives and analyzes the authority information sent from the policy managing apparatus 50 and determines which operation is permitted.

Specifically, based on the authority information sent from the policy managing apparatus 50, the document process permission control unit 366 determines whether or not a document process (scan, copy, etc.) corresponding to the user operation (scan start operation: start instruction operation of scan, copy, etc.) in Step S321, which is the cause of this scan, is permitted (Step S328).

If it is determined that the document process corresponding to the scan start operation in Step S321 is not permitted (non permission in Step S328), the document process permission control unit 366 displays an error message indicating the fact on the displaying/operating unit 35 (Step S329), and then, the process returns to a scan start operation standby state.

On the other hand, if it is determined that the document process corresponding to the scan start operation in Step S321 is permitted (permission in Step S328), first, the document process permission control unit 366 instructs the document generation processing unit 364 to generate a document file based on the scan data obtained by the scan operation (Step S322).

Then, the document process permission control unit 366 informs the user that the document file is generated by, for example, displaying a message such as “Document file is generated” on the displaying/operating unit 35 (Step S330).

Thereafter, the controller 36 controls each unit to perform the document process (Step S340) determined to be permitted in Step S328 for the document file generated by the document generation processing unit 364 in Step S330.

FIG. 13 is a view showing a control sequence between the image forming apparatus 30 and the document managing apparatus 20, which is related to the document file generating process in Step S330 of FIG. 12.

The document file generating process (Step S330) starts when the document process permission control unit 366 determines in Step S328 of FIG. 12, based on the authority information sent from the policy managing apparatus 50, that the user has the document process authority corresponding to the scan start operation in Step S321 (permission in Step S328) for the document process authority inquiry request based on the page IDs extracted from the scan data and the user ID acquired from the user.

In the document file generating process (Step S330), first, the information registering/acquiring unit 363 accesses the document managing apparatus 20 with the page ID extracted by the page ID extracting unit 362 as a key, and acquires document ID information of an electronic document of a print source corresponding to the page ID stored in the print document attribute managing table 222 (Step S331).

In the process of Step S331, the information registering/acquiring unit 363 of the image forming apparatus 30 sends a document attribute acquisition request including the page ID to the document managing apparatus 20 (Step S3311).

When the process request receiving unit 241 of the document managing apparatus 20 receives the document attribute acquisition request sent from the image forming apparatus 30, the information acquisition and delivery processing unit 243 searches a document ID corresponding to the page ID included in the registration request from the print document attribute managing table 222 with the page ID as a key, and sends an acquisition request response signal including the document ID as a result of the search to the image forming apparatus 30 as an acquisition request source (Step S221: print document attribute information search and delivery process).

In the mean time, in the image forming apparatus 30, the information registering/acquiring unit 363 receives the response signal to the document attribute acquisition request, which is sent from the document managing apparatus 20, and acquires the document ID included in the response signal.

When the information registering/acquiring unit 363 acquires the document ID of the print source document corresponding to the page ID extracted by the page ID extracting unit 362, the document generation processing unit 364 first stores the acquired document ID in association with scan data having the page ID used as an acquisition key of the document ID (scan data from which the page ID is extracted), subsequently sorts (classifies) the scan data with the acquired document ID as a key (Step S335), and then generates one document file, which is composed of continued pages as a collection of scan data associated with the document ID (Step S337).

When the document file generating process in Step S330 is ended, the controller 36 proceeds to a document process for the generated document file (Step S340 in FIG. 12).

Next, an example of a series of sheet document scan processes shown in FIGS. 12 and 13 will be described with reference to FIG. 14.

FIG. 14(a) shows an example in which three sheet documents 3401 (sheet document a), 3402 (sheet document b) and 3403 (sheet document c) obtained by printing document 1 [see FIG. 10(a)] and two sheet documents 3411 (sheet document d) and 3412 (sheet document e) obtained by printing document 2 [see FIG. 10(b)] are set on a sheet feeder of the image forming apparatus 30 in a read order of sheet documents 3402, 3412, 3403, 3411 and 3401, for example, and are sequentially scanned.

In this set state, when a scan start operation is performed in Step S321 of FIG. 12, likely, a scan operation is performed in an order of sheet documents 3402, 3412, 3403, 3411 and 3401 through Steps S322 to S324, and accordingly, scan data 1, 2, 3, 4 and 5 corresponding to images of the sheet documents 3402, 3412, 3403, 3411 and 3401, respectively, are obtained [see FIG. 14(b)].

Next, in Step S325 of FIG. 12, based on data of page ID regions of the scan data 1, 2, 3, 4 and 5, the page ID extracting unit 362 extracts a page ID (=P0012) given to the sheet document 3402, a page ID (=P0022) given to the sheet document 3412, a page ID (=P0013) given to the sheet document 3403, a page ID (=P0021) given to the sheet document 3411, and a page ID (=P0011) given to the sheet document 3401 [see FIG. 14(c)].

In addition, the information registering/acquiring unit 363 acquires a document ID (=docu001) of electronic document 1 of a print source, a document ID (=docu002) of electronic document 2 of a print source, a document ID (=docu001) of electronic document 1, a document ID (=docu002) of electronic document 2, and a document ID (=docu001) of electronic document 1, which correspond to the page IDs (=P0012, P0022, P0013, P0021 and P0011) extracted by the page ID extracting unit 363, respectively, from the print document attribute managing table 222 (see FIG. 11) stored in the document managing apparatus 20, with the page IDs (=P0012, P0022, P0013, P0021 and P0011) as respective keys, and stores the acquired document IDs in association with the corresponding scan data 1, 2, 3, 4 and 5 [see FIG. 14(d): corresponding to Step S331 of FIG. 13].

In addition, the document generation processing unit 364 sorts (classifies) the scan data 1, 2, 3, 4 and 5 with two document IDs (=docu001 and docu002) acquired by the information registering/acquiring unit 363 as respective keys, and generates one document file 31 in which the scan data 1, 3 and 5 having (associated with) the document ID (=docu001) are arranged as continued pages, and then, the scan data 2 and 4 having (associated with) the document ID (=docu002) are arranged as continued pages [see FIG. 14(e): corresponding to Steps S335 and S337 of FIG. 13].

As illustrated in FIGS. 13 and 14, in the image forming apparatus 30 according to this embodiment, for example, even when the plurality of sheet documents 3401, 3402 and 3403 on which electronic document data of pages of document 1 are printed and the plurality of sheet documents 3411 and 3412 on which electronic document data of pages of document 2 are printed are set and scanned in any read order, after the scan operation (see Steps S321 YES to S324 of FIG. 12), the document generation processing unit 364 generates the document file 31 in which the scan data 1, 3 and 5 of the sheet documents with document 1 as a derivative source are arranged as continued pages (scan order in between document 1), and subsequently, the scan data 2 and 4 of the sheet documents with document 2 as a derivative source are arranged as continued pages (scan order in between document 2), according to the document file generating process in Step S330 of FIG. 12.

The image forming apparatus 30 according to this embodiment generates the document file 31 in Step S330 and performs the process of registering the generated document file 31 as a derivative document from a sheet document, printing the document file 31, etc. (see Step S340 of FIG. 12).

Here, whether the document file generated in Step S330 is registered or printed depends on contents of the scan start operation performed in Step S321, for example.

Specifically, if an operation of instructing conservation of scan data is performed (for example, if a “sheet document read” button is pressed) as the scan start operation, a process of registering the document file generated in Step S330 is performed based on the scan data obtained by the scan operation in Steps S322 to S324. In the mean time, if an operation of instructing print of the scan data is performed (for example, if a “copy” button is pressed), a process of printing the document file generated in Step S330 is performed.

Now, as an example of the derivative document process in Step S340 of FIG. 12, a process (Step S340-1) of registering the document file generated in Step S330 of FIG. 12 in a new repository will be described with reference to a control sequence shown in FIG. 15.

The document registering process in Step S340-1 starts when a user presses a “sheet document injection” button in Step S321 of FIG. 12, it is determined that the user has authority of “sheet document injection=scan” based on a page ID and a user ID extracted from scan data obtained by sequentially scanning a plurality of sheet documents, and then, a document file in which scan data of the plurality of sheet documents are arranged as continued pages for document IDs of electronic documents of a print source of the sheet documents is generated according to the document file generating process shown in FIG. 13.

In the document registering process (Step S340-1), first, the information registering/acquiring unit 363 reads the document file generated in Step S330, specifically, the document file 31 shown in FIG. 14(e), from a temporal storing region of the storing unit 33 (Step S341), and generates a document ID corresponding to the document file 31 to be newly registered by having a user input a desired document ID through an operation guidance which is displayed on the displaying/operating unit 35 to urge the user to input the document ID (Step S342).

Thereafter, the information registering/acquiring unit 363 sequentially performs the process (Step S343) of registering the document file 31 read (acquired) in Step S341 and the process (Step S344) of registering various data (meta data related to the registration of the document file 31: electronic document meta data) including the document ID generated in Step S342.

When the document file 31 is registered in Step S343, the information registering/acquiring unit 363 sends a registration request including the document file 31 to the document managing apparatus 20 (Step S341).

In the mean time, in the document managing apparatus 20, when the process request receiving unit 241 receives the electronic document registration request sent from the image forming apparatus 30, the information managing unit 242 stores the document file 31 included in the registration request in, for example, a predetermined storing site of the storing device 23 (Step S231: electronic document registering process).

In addition, when the electronic document meta data are registered in Step S344, the information registering/acquiring unit 363 sends a registration request including the document ID generated in Step S342 and various meta data related to the document registration to the document managing apparatus 20 (Step S3441).

In the mean time, in the document managing apparatus 20, when the process request receiving unit 241 receives the electronic document meta data registration request sent from the image forming apparatus 30, the information managing unit 242 stores the document ID included in the registration request and a corresponding storing site of the electronic document data in Step S231 in, for example, the registration document attribute managing table 221 of the storing unit 22 (Step S232: electronic document meta data registering process).

FIG. 16 is a table diagram showing an example of registration information of the registration document attribute managing table 221 in the document managing apparatus 20 after the document file registration process in FIG. 15.

In this example, under a condition where the registration document attribute managing table 221 contains the registration contents shown in FIG. 8, a sheet document scan operation is performed according to a flow shown in FIG. 12, the document file 31 in which the scan data 1, 3 and 5 of sheet documents with document 1 as a derivative source and the scan data 2 and 4 of sheet documents with document 2 as a derivative source are arranged is generated in Step S330 of FIG. 12 (see FIG. 13), based on the scan data obtained by the scan operation [see FIG. 14(e)], and, in accord with the process of newly storing the generated document file 31 in the storing device 23 according to the flow shown in FIG. 15, a document ID (=docu301) of the document file 31 and a storing site (=ftp://xxxxv) in the storing device 23 of the document file 31 are additionally registered in correspondence therebetween.

Next, as an example of the derivative document process in Step S340 of FIG. 12, a process (Step S340-2) of printing the document file 31 generated in Step S330 of FIG. 12 will be described with reference to a control sequence shown in FIG. 17.

In FIG. 17, the same process steps as the process steps in the derivative document registration in FIG. 15 are denoted by the same reference numerals.

The document printing process in Step S340-2 starts when a user presses a “copy” button in Step S321 of FIG. 12, it is determined that the user has authority of “copy” based on a page ID and a user ID extracted from scan data obtained by sequentially scanning a plurality of sheet documents, and then, the document file 31 is generated in Step S330 (see FIG. 13).

In the document printing process (Step S340-2), like the document registering process shown in FIG. 15, the document file 31 generated in Step S330 is read from the storing unit 33 (Step S341), and processes (Steps S342, S343 and S344) of giving a new document ID to the read document file 31, registering the document file 31 having the new document ID in the storing device 23 of the document managing apparatus 20, and registering meta data related to the registration of the document file 31 in the registration document attribute managing table 221 are performed in cooperation with the document managing apparatus (Steps S231 and S232).

After completion of the registration of the document file 31 and the meta data, the controller 36 analyzes the electronic document data [(scan data 1, 3 and 5) and (scan data 2 and 4): see FIG. 14(e)] of pages included in the document file 31 and generates logical page numbers and page IDs of the pages (Step S351).

The document attribute information generating process in Step S351 may be realized by the same process as the process in Step S125 of FIG. 9 in the client terminal 10.

Subsequently, the print control unit 361 generates a print job based on the page IDs generated in correspondence to the electronic document data of the document file 31 acquired in Step S341 (generated in Step S340) and the electronic document data of the pages of the document file 31 in Step S351 (Step S352).

Here, the print control unit 361 generates a print job describing a drawing instruction to draw the electronic document data of the pages of the document file 31 as a print object by giving the pages the corresponding page IDs, more specifically, an instruction to draw the electronic document data of the pages and a QR code corresponding to Hash values calculated as the page IDs based on the electronic document data of the pages.

After generating the print job, the information registering/acquiring unit 363 registers the document ID corresponding to the document file 31 generated in Step S342 and the logical page numbers and page IDs of the pages in the document file 31 generated in Step S351 in correspondence therebetween (Step S353).

In the print document attribute information registering process, the information registering/acquiring unit 363 sends a registration request including the document ID of the document file 31 as the print object and the logical page numbers and page IDs of the pages of the document file 31 (Step S3531).

In the mean time, in the document managing apparatus 20, when the process request receiving unit 241 receives the print document attribute registration request sent from the image forming apparatus 30, the information managing unit 242 extracts the document ID, the logical page numbers and page IDs of the pages, and page size included in the registration request individually, and stores the extracted information in, for example, the print document attribute managing table 222 of the storing unit 22 in correspondence therebetween (Step S233: print document attribute and meta data registering process).

Thereafter, the print control unit 361 performs a process (Step S354) of printing the document file 31 as a sheet document based on the print job generated in Step S352.

This sheet document printing process may be realized by the same process as the process in Step S301 in FIG. 9 based on the print instruction from the client terminal 10.

According to this sheet document printing process, for example, when the document file 31 obtained as shown in FIG. 14(e) by scanning sheet documents is to be printed, five sheet documents [for example, sheet documents aa, bb, cc (their derivative source sheet documents are sheet documents b, c and a, respectively), dd and ee (their derivative source sheet documents are sheet documents e and d, respectively): see FIG. 14] having image contents corresponding to scan data 1, 3, 5, 2 and 4, respectively, and having new page IDs printed (given) corresponding to respective pages are printed and outputted.

In this manner, in the image forming apparatus 30, when one document file 31 is generated from individual scan data of a plurality of sheet documents and is printed and outputted as sheet documents aa, bb, cc, dd and ee with respective page IDs, a new document ID corresponding to the document file 31 is generated (S342 of FIG. 17), and then, the document file 31 (data body) is stored in the storing device 23 of the document managing apparatus 20 (Step S343 of FIG. 17). Then, the document ID corresponding to the document file 31 and a storing site of the document file 31 are stored in the registration document attribute managing table 221 of the document managing apparatus 20 in correspondence therebetween, while the page IDs and page numbers of pages of the document file 31 are stored in the print document attribute managing table 222 in correspondence to the document ID corresponding to the printed document file 31.

FIG. 18 is a table diagram showing an example of information stored in the registration document attribute managing table 221 and the print document attribute managing table 222 of the document managing apparatus 20 after the scan document printing process in FIG. 17.

In this example, under a condition where the print document attribute managing table 222 contains the registration contents shown in FIG. 11, as the document file 31 is printed according to the process shown in FIG. 17, a document ID (=docu301) identifying the document file 31 is generated, page IDs (=P3011, P3012, P3013, P3014 and P3015) and page numbers 1, 2, 3, 4 and 5 are generated for the sheet documents aa, bb, cc, dd and ee on which electronic document data of the pages of the document file 31 are printed, respectively, and, based on the generated document attribute information, in correspondence to the document ID (=docu301) of the document file 31, the page IDs P3011, P3012, P3013, P3014 and P3015 identifying the sheet documents aa, bb, cc, dd and ee printed based on the document file 31 and the page numbers 1, 2, 3, 4 and 5 are additionally registered in correspondence therebetween.

In addition, under a condition where the storing sites (ftp://xxxxx and ftp://yyyyy) are stored in the registration document attribute information managing table 221 in correspondence to the document ID (=docu001) and the document ID (=docu002) of document 1 and document 2 which were already printed, respectively, when the document file 31 is printed based on the process shown in FIG. 17, a storing site (ftp://xxxxw) is additionally registered in the registration document attribute information managing table 221 in correspondence to a document ID (=docu301) corresponding to the document file 31.

### SECOND EMBODIMENT

In an image forming apparatus 30 (conveniently denoted by reference numeral 30B: not shown) according to a second embodiment, in the document file generating process in Step S330 of a series of sheet document scan processing operations shown in FIG. 12, a document generation processing unit 364 (similarly denoted by reference numeral 364b) provided in the controller 36 (see FIG. 4) has a document file generation processing function of acquiring a document ID and page numbers of an electronic document of a print source, which correspond to page IDs extracted from scan data obtained by scanning a plurality of sheet documents, from the document managing apparatus 20, based on the extracted page IDs, sorting the scan data with the acquired document ID and page numbers of the electronic document of the print source as keys, and generating a different document file in which scan data having the same electronic document of the print source are arranged in a page order of electronic document data on which print of the sheet documents corresponding to the scan data is based.

In addition, in order to realize this document file generating process, an information registering/acquiring unit 363 (similarly denoted by reference numeral 363b) in the controller 36 has a processing function of acquiring the document ID and logical page numbers of the electronic document of the print source, which correspond to the page IDs extracted from the scan data of the sheet documents, from the document managing apparatus 20 based on the extracted page IDs.

Other functional blocks in the image forming apparatus 30B has the same configuration as in the first embodiment (see FIG. 4). In addition, the functional block configuration of other apparatuses (the client terminal 10, the document managing apparatus 20, the user attribute information managing apparatus 40 and the policy managing apparatus 50) in the image processing system of the second embodiment, and interconnection of apparatuses including the image forming apparatus 30B are the same as in the first embodiment.

Next, an operation of the system according to this embodiment will be described.

In the image forming apparatus 30B according to this embodiment, the controller 36 integrally controls the reading unit 31, the displaying/operating unit 35, the page ID extracting unit 362, the information registering/acquiring unit 363, the document process permission control unit 366, etc. to perform a series of sheet document scan processing operations including the steps shown in FIG. 12.

In the series of sheet document scan processing operations, by extracting page IDs from the scan data obtained in the scan operation (Step S322 to S324) of the sheet documents by the page ID extracting unit 362 (Step S325), performing a document process authority inquiry request (Step S326) based on the extracted page IDs and a user ID acquired from a user in the user authentication process (Step S311), acquiring authority information sent from the policy managing apparatus 50 for the request (Step S327), and determining by the document process permission control unit 366 that the user has document process authority corresponding to the scan start operation in Step S321 (permission in Step S328), the document file generating process in Step S330 starts based on the scan data obtained by the time.

FIG. 19 is a view showing a control sequence between the image forming apparatus 30B and the document managing apparatus 20, which is related to the document file generating process (corresponding to Step S330 of FIG. 12: conveniently denoted by Step S330b) in the image forming apparatus 30B according to the second embodiment.

In the document file generating process (Step S330b) shown in FIG. 19, in the image forming apparatus 30B, first, the information registering/acquiring unit 363b accesses the document managing apparatus 20 with the page ID extracted by the page ID extracting unit 362 as a key (see Step S325 of FIG. 12), and acquires a document ID and page numbers of an electronic document of a print source corresponding to the page ID, which are stored in the print document attribute managing table 222 (Step S331b).

In the process of Step S331b, the information registering/acquiring unit 363 of the image forming apparatus 30B sends a document attribute acquisition request including the page ID to the document managing apparatus 20 (Step S3311b).

On the other hand, when the process request receiving unit 241 of the document managing apparatus 20 receives the document attribute acquisition request sent from the image forming apparatus 30B, the information acquisition and delivery processing unit 243 searches a document ID and logical page numbers of the pages corresponding to the page ID included in the registration request from the print document attribute managing table 222 with the page ID as a key, and sends an acquisition request response signal including the searched document ID and logical page numbers to the image forming apparatus 30B as an acquisition request source (Step S221b: print document attribute information search and delivery process).

In the mean time, in the image forming apparatus 30B, the information registering/acquiring unit 363b receives the response signal to the document attribute acquisition request, which is sent from the document managing apparatus 20, and acquires the document ID and page numbers included in the response signal.

When the information registering/acquiring unit 363b acquires the document ID and page numbers of the print source document corresponding to the page ID extracted by the page ID extracting unit 362, the document generation processing unit 364b first stores the acquired document ID and page numbers in association with scan data having the page ID used as an acquisition key of the document ID and page numbers (scan data from which the page ID is extracted).

Subsequently, the document generation processing unit 364b sorts the scan data associated with the document ID and page numbers acquired in Step S331b with the document ID acquired in Step S331b as a first key and the page numbers acquired in Step S331b according to the document ID as a second key (Step S336), and then generates a different document file in which the scan data associated with the document ID are sorted in a page order in the electronic document of the print source corresponding to the document ID acquired in Step S331b (Step S338).

When the document file generating process in Step S338 is ended, the controller 36 proceeds to a document process for the generated document file (Step S340 in FIG. 12).

In addition, for the process of Step S340, like the first embodiment, for example, a process of giving a document ID to the document file generated in Step S330b and registering the document file having the document ID in a new repository (see FIG. 15) or a process of printing the document file (see FIG. 17) is performed.

Next, an example of a series of sheet document scan processes (see FIGS. 12 and 19) in the image forming apparatus 30B according to this embodiment will be described with reference to FIG. 20.

Like FIG. 14(a), FIG. 20 shows an example in which three sheet documents 3401 (sheet document a), 3402 (sheet document b) and 3403 (sheet document c) obtained by printing document 1 and two sheet documents 3411 (sheet document d) and 3412 (sheet document e) obtained by printing document 2 are set on a sheet feeder of the image forming apparatus 30 in a read order of sheet documents 3402, 3412, 3403, 3411 and 3401, for example, and are sequentially scanned [FIG. 20(a)].

In this example, the processes of sheet document scan [FIG. 20(a)], scan data storage [FIG. 20(b)] and page ID extraction [FIG. 20(c)] in the image forming apparatus 30 are performed in the same way as FIGS. 14(a), 14(b) and 14(c), respectively.

After the page ID extracting process in FIG. 20(c), the information registering/acquiring unit 363b of the image forming apparatus 30B acquires a document ID (=docu001) and a page number (=2) of electronic document 1 of a print source, a document ID (=docu002) and a page number (=2) of electronic document 2 of a print source, a document ID (=docu001) and a page number (=3) of electronic document 1, a document ID (=docu002) and a page number (=1) of electronic document 2, and a document ID (=docu001) and a page number (=1) of electronic document 1, which correspond to the page IDs (=P0012, P0022, P0013, P0021 and P0011) extracted from scan data 1, 2, 3, 4 and 5 in the page ID extracting process by the page ID extracting unit 363, respectively, from the print document attribute managing table 222 (see FIG. 11) stored in the document managing apparatus 20, with the page IDs (=P0012, P0022, P0013, P0021 and P0011) as respective keys, and stores the acquired document IDs and page numbers in association with the corresponding scan data 1, 2, 3, 4 and 5 [see FIG. 20(d): corresponding to Step S331b of FIG. 19].

Subsequently, the document generation processing unit 364b first classifies scan data 1, 2, 3, 4 and 5 associated with the acquired document IDs and page numbers into scan data 1, 3 and 5 associated with document ID (=docu001) and scan data 2 and 4 associated, with document ID (=docu002) with document IDs (=docu001 and docu002) acquired in FIG. 20(d) as keys (first keys), sorts scan data 1, 3 and 5 into a second page, a third page and a first page while sorting scan data 2 and 4 into a second page and a first page for a set of scan data 1, 3 and 5 and scan data 2 and 4 classified for respective document IDs (=docu001 and docu002), with page numbers (=2, 3 and 1) acquired corresponding to the document ID (=docu001) and page numbers (=2 and 1) acquired corresponding to the document ID (=docu002) in FIG. 20(d) as keys (second keys), and generates a document file 32 and a document file 33 in which scan data 1, 3 and 5 and scan data 2 and 4, which are respectively associated with the document IDs (=docu001 and docu002) acquired in FIG. 20(d), are sorted in a page order in electronic documents 1 and 2 of a print source corresponding to the document IDs (=docu001 and docu002) [see FIG. 20(e): corresponding to Steps S336 and S338 of Gig. 19].

As shown in FIGS. 19 and 20, in the image forming apparatus 30B according to this embodiment, for example, even when the plurality of sheet documents 3401, 3402 and 3403 on which electronic document data of pages of document 1 are printed and the plurality of sheet documents 3411 and 3412 on which electronic document data of pages of document 2 are printed are set and scanned in any order, after the scan operation (see Steps S321 YES to S324 of FIG. 12), the document generation processing unit 364b generates the document file 32 in which the scan data 1, 3 and 5 of the sheet documents with document 1 as a derivative source are sorted in a page order of document 1 and the document file 33 in which the scan data 2 and 4 of the sheet documents with document 2 as a derivative source are sorted in a page order of document 2, according to the document file generating process in Step S330b in FIG. 19, which corresponds to Step S330 in FIG. 12.

### THIRD EMBODIMENT

In an image forming apparatus 30 (conveniently denoted by reference numeral 30C: not shown) according to a third embodiment, in the document file generating process in Step S330 of a series of sheet document scan processing operations shown in FIG. 12, a document generation processing unit 364 (similarly denoted by reference numeral 364c) provided in the controller 36 (see FIG. 4) has a document file generation processing function of acquiring page numbers of an electronic document of a print source, which correspond to page IDs extracted from scan data obtained by scanning a plurality of sheet documents, from the document managing apparatus 20, based on the extracted page IDs, sorting the scan data with the acquired page numbers of the electronic document of the print source as a key, and generating one document file in which scan data are arranged in a page order of electronic document data on which print of the sheet documents corresponding to the scan data is based.

In addition, in order to realize this document file generating process, an information registering/acquiring unit 363 (similarly denoted by reference numeral 363c) in the controller 36 has a processing function of acquiring the logical page numbers of the electronic document of the print source, which correspond to the page IDs extracted from the scan data of the sheet documents, from the document managing apparatus 20 based on the extracted page IDs.

Other functional blocks in the image forming apparatus 30C has the same configuration as in the first embodiment (see FIG. 4). In addition, the functional block configuration of other apparatuses (the client terminal 10, the document managing apparatus 20, the user attribute information managing apparatus 40 and the policy managing apparatus 50) in the image processing system of the second embodiment, and interconnection of apparatuses including the image forming apparatus 30C are the same as in the first embodiment.

FIG. 21 is a view showing a control sequence between the image forming apparatus 30C and the document managing apparatus 20, which is related to the document file generating process (corresponding to Step S330 of FIG. 12: conveniently denoted by Step S330c) in the image forming apparatus 30C according to the third embodiment.

The document file generating process (Step S330c) shown in FIG. 21 starts by extracting page IDs from the scan data obtained in the scan operation (Step S322 to S324) of the plurality of sheet documents having the same electronic document of the print source by the page ID extracting unit 362 (Step S325), performing a document process authority inquiry request (Step S326) based on the extracted page IDs and a user ID acquired from a user in the user authentication process (Step S311), acquiring authority information sent from the policy managing apparatus 50 for the request (Step S327), and determining by the document process permission control unit 366 that the user has document process authority corresponding to the scan start operation in Step S321 (permission in Step S328) in the series of sheet document scan processing operations.

In the process of Step S330c, in the image forming apparatus 30C, first, the information registering/acquiring unit 363c accesses the document managing apparatus 20 with the page ID extracted by the page ID extracting unit 362 as a key (see Step S325 of FIG. 12), and acquires page numbers of an electronic document of a print source corresponding to the page ID, which are stored in the print document attribute managing table 222 (Step S331c).

Subsequently, the document generation processing unit 364c sorts the scan data with the acquired page numbers with a key, and generates one document file in which the scan data are sorted in a page order of the pages of the electronic document of the print source (Step S339).

### FOURTH EMBODIMENT

In an image forming apparatus 30 (conveniently denoted by reference numeral 30D: not shown) according to a fourth embodiment, in the document file generating process in Step S330 of a series of sheet document scan processing operations shown in FIG. 12, a document generation processing unit 364 (similarly denoted by reference numeral 364d) provided in the controller 36 (see FIG. 4) has a document file generation processing function of acquiring a document ID and electronic document data (instance data) of a page of an electronic document of a print source, which correspond to page IDs extracted from scan data obtained by scanning a plurality of sheet documents, from the document managing apparatus 20, based on the extracted page IDs, sorting the acquired electronic document data with the document ID acquired along with the electronic document data as a key, and generating one document file in which the electronic document data on which print of the sheet documents corresponding to the scan data is based are arranged as continued pages for the same electronic document of the print source.

In addition, in order to realize this document file generating process, an information registering/acquiring unit 363 (similarly denoted by reference numeral 363d) in the controller 36 has a processing function of acquiring the document ID and the electronic document data of the page of the electronic document of the print source, which correspond to the page IDs extracted from the scan data of the sheet documents, from the document managing apparatus 20 based on the extracted page IDs.

Other functional blocks in the image forming apparatus 30D has the same configuration as in the above embodiments (see FIG. 4).

In addition, the functional block configuration of other apparatuses (the client terminal 10, the document managing apparatus 20, the user attribute information managing apparatus 40 and the policy managing apparatus 50) in the image processing system of the fourth embodiment, and interconnection of apparatuses including the image forming apparatus 30D are the same as in the first embodiment.

FIG. 22 is a view showing a control sequence between the image forming apparatus 30D and the document managing apparatus 20, which is related to the document file generating process (corresponding to Step S330 of FIG. 12: conveniently denoted by Step S330d) in the image forming apparatus 30D according to the fourth embodiment.

The document file generating process (Step S330c) shown in FIG. 22 starts by extracting page IDs from the scan data obtained in the scan operation (Step S322 to S324) of the sheet documents by the page ID extracting unit 362 (Step S325), performing a document process authority inquiry request (Step S326) based on the extracted page IDs and a user ID acquired from a user in the user authentication process (Step S311), acquiring authority information sent from the policy managing apparatus 50 for the request (Step S327), and determining by the document process permission control unit 366 that the user has document process authority corresponding to the scan start operation in Step S321 (permission in Step S328) in the series of sheet document scan processing operations shown in FIG. 12.

In the process of Step S330d, in the image forming apparatus 30D, first, the information registering/acquiring unit 363d accesses the document managing apparatus 20 with the page ID extracted by the page ID extracting unit 362 as a key (see Step S325 of FIG. 12), and acquires a document ID of an electronic document of a print source corresponding to the page ID, which is stored in the print document attribute managing table 222 (Step S331).

This document ID acquisition process may be realized by the same process as Step S331 in the document file generating process (see FIG. 13) in the first embodiment.

In Step S331, after acquiring the document ID corresponding to the page ID extracted from the scan data, the information registering/acquiring unit 363d again accesses the document managing apparatus 20 with the acquired document ID and the page ID extracted by the page ID extracting unit 362 as keys, and acquires electronic document data (instance data) of the page corresponding to the page ID of the electronic document of the print source, which corresponds to the document ID (Step S332).

In the process of Step S332, the information registering/acquiring unit 363d sends an instance data acquisition request including the page ID acquired in Step S325 (see FIG. 12) and the document ID acquired in Step S331 based on the page ID to the document managing apparatus 20 (Step S3321).

On the other hand, when the process request receiving unit 241 of the document managing apparatus 20 receives the instance data acquisition request sent from the image forming apparatus 30D, the information acquisition and delivery processing unit 243 reads electronic document data (instance data) of a page corresponding to the page ID corresponding to the document ID from a storing site of the storing device 23, which is stored in the registration document attribute managing table 221 in correspondence to the document ID, with the document ID and the page ID included in the registration request as keys, and sends an acquisition request response signal including the read instance data to the image forming apparatus 30D as an acquisition request source (Step S221d: print document/attribute information search and delivery process).

In the mean time, in the image forming apparatus 30D, the information registering/acquiring unit 363d receives the response signal to the instance data acquisition request, which is sent from the document managing apparatus 20, and acquires the instance data included in the response signal.

When the information registering/acquiring unit 363d acquires the document ID and the instance data of the page of the print source document corresponding to the page ID extracted by the page ID extracting unit 362, the document generation processing unit 364d sorts (classifies) the instance data acquired in Step S332 with the document ID acquired in Step S331 as a key (Step S335d), and generates one document file in which the instance data corresponding to the document ID are arranged as continued pages (Step S337d).

In addition, the processes in Steps S335d and S337d may be realized by the same processes as Steps S335 and S337 in the document file generating process (see FIG. 13) of the first embodiment only by changing a sort object from scan data to the instance data of the page of the print source document corresponding to the page ID extracted from the scan data.

When the document file generating process in Step S337d is ended, the controller 36 proceeds to a document process for the generated document file (Step S340 in FIG. 12).

In addition, for the process of Step 340, like the first embodiment, for example, a process of giving a document ID to the document file generated in Step S330d and registering the document file having the document ID in a new repository (see FIG. 15) or a process of printing the document file (see FIG. 17) is performed.

### FIFTH EMBODIMENT

In an image forming apparatus 30 (conveniently denoted by reference numeral 30E: not shown) according to a fifth embodiment, in the document file generating process in Step S330 of a series of sheet document scan processing operations shown in FIG. 12, a document generation processing unit 364 (similarly denoted by reference numeral 364e) provided in the controller 36 (see FIG. 4) has a document file generation processing function of acquiring a document ID, logical page numbers and electronic document data (instance data) of a page of an electronic document of a print source, which correspond to page IDs extracted from scan data obtained by scanning a plurality of sheet documents, from the document managing apparatus 20, based on the extracted page IDs, sorting the acquired electronic document data with the document ID and the logical page numbers acquired along with the electronic document data as keys, and generating different document files in which the electronic document data on which print of the sheet documents corresponding to the scan data is based are arranged in a page order in the electronic document of the print source.

In addition, in order to realize this document file generating process, an information registering/acquiring unit 363 (similarly denoted by reference numeral 363e) in the controller 36 has a processing function of acquiring the document ID, the logical page numbers and the electronic document data of the page of the electronic document of the print source, which correspond to the page IDs extracted from the scan data of the sheet documents, from the document managing apparatus 20 based on the extracted page IDs.

Other functional blocks in the image forming apparatus 30E has the same configuration as in the above embodiments (see FIG. 4).

In addition, the functional block configuration of other apparatuses (the client terminal 10, the document managing apparatus 20, the user attribute information managing apparatus 40 and the policy managing apparatus 50) in the image processing system of the fifth embodiment, and interconnection of apparatuses including the image forming apparatus 30E are the same as in the first embodiment.

FIG. 23 is a view showing a control sequence between the image forming apparatus 30E and the document managing apparatus 20, which is related to the document file generating process (corresponding to Step S330 of FIG. 12: conveniently denoted by Step S330e) in the image forming apparatus 30E according to the fifth embodiment.

The document file generating process (Step S330e) shown in FIG. 23 starts by extracting page IDs from the scan data obtained in the scan operation (Step S322 to S324) of the sheet documents by the page ID extracting unit 362 (Step S325), performing a document process authority inquiry request (Step S326) based on the extracted page IDs and a user ID acquired from a user in the user authentication process (Step S311), acquiring authority information sent from the policy managing apparatus 50 for the request (Step S327), and determining by the document process permission control unit 366 that the user has document process authority corresponding to the scan start operation in Step S321 (permission in Step S328) in the series of sheet document scan processing operations shown in FIG.

In the process of Step S330e, in the image forming apparatus 30E, first, the information registering/acquiring unit 363e accesses the document managing apparatus 20 with the page ID extracted by the page ID extracting unit 362 as a key (see Step S325 of FIG. 12), and acquires a document ID and logical page numbers of an electronic document of a print source corresponding to the page ID, which is stored in the print document attribute managing table 222 (Step S331e).

This document ID and page numbers acquisition process may be realized by the same process as Step S331b in the document file generating process (see FIG. 19) in the second embodiment.

In Step S331e, after acquiring the document ID and the page numbers corresponding to the page ID extracted from the scan data, the information registering/acquiring unit 363e again accesses the document managing apparatus 20 with the acquired document ID and the page ID extracted by the page ID extracting unit 362 as keys, and acquires electronic document data (instance data) of the page corresponding to the page ID of the electronic document of the print source, which corresponds to the document ID (Step S332).

This instance data acquiring process may be realized by the same process as Step having the same reference numeral in the document file generating process (see FIG. 22) of the fourth embodiment in cooperation with the print document/attribute information search and delivery process (Step S221e) in the document managing apparatus 20.

In Steps S331e and S332, when the information registering/acquiring unit 363e acquires the document ID, the page number and the instance data of the page of the print source document corresponding to the page ID extracted by the page ID extracting unit 362, the document generation processing unit 364e sorts the instance data (corresponding to the scan data) acquired in Step S332 with the document ID acquired in Step S331e as a first key and with the page numbers acquired corresponding to the document ID in Step S331e as a second key (Step S336e), and generates different document files in which the electronic document data on which print of sheet documents corresponding to the scan data is based are sorted in a page order in the electronic document of the print source in the unit of electronic document of the print source (Step S338e).

In addition, the processes in Steps S336e and S338e may be realized by the same processes as Steps S336 and S338 in the document file generating process (see FIG. 19) of the second embodiment only by changing a sort object from scan data to the instance data of the page of the print source document corresponding to the page ID extracted from the scan data.

When the document file generating process in Step S338e is ended, the controller 36 proceeds to a document process for the generated document file (Step S340 in FIG. 12).

For the process of Step 340, like the first embodiment, for example, a process of giving a document ID to the document file generated in Step S330e and registering the document file having the document ID in a new repository (see FIG. 15) or a process of printing the document file (see FIG. 17) is performed.

The invention is not limited to the illustrated and shown embodiments, but may be modified in various ways without departing from the spirit of the invention.

For example, although it is configured in the above embodiments that the document managing apparatus 20 has the function of managing page size information of the electronic document corresponding to the page IDs given to the sheet documents on which the electronic document data are printed, the managing function may be provided in the client terminal 10 or the image forming apparatus 30 without any limitation.

In addition, the above embodiments illustrate the system configured to include the image forming apparatus (multifunction copier) that integrates the function of scanning the sheet documents having the page IDs and the function of extracting the page IDs from the scan data of the sheet documents, acquiring the document ID, the page numbers and so on corresponding to the page IDs and classifying or sorting the scan data based on the acquired document ID or page numbers, however, the invention is not limited to this, but may provide a system configured to include a print apparatus that prints sheet documents having page IDs given to pages of the sheet documents, a managing apparatus that manages a document ID, page numbers and so on of an electronic document of a print source in correspondence to the page IDs given to the sheet documents, a reading apparatus that reads image information including the page IDs from the sheet documents having the page IDs, and a document processing apparatus that extracts the page IDs from the image information (scan data) read by the reading apparatus, acquires the document ID, the page numbers and so on corresponding to the page IDs based on the extracted page IDs, and classifies or sorts the scan data based on the acquired document ID or page numbers.

In addition, in the above embodiments, an image processing program is installed in the client terminal, the document managing apparatus, the image forming apparatus and so on (conveniently referred to as computers), and the image processing program causes the computers to function as, for example, an extracting unit that extracts the page IDs given to the sheet documents from the image information (scan data) read from the sheet documents by the reading unit, an acquiring unit that acquires the document ID and the page numbers, which correspond to the page IDs extracted by the extracting unit, from a managing unit based on the extracted page IDs, a classifying unit that classifies the scan data read by the reading unit based on the document ID acquired by the acquiring unit, a sorting unit that sorts the scan data classified by the classifying unit, which correspond to the document ID, based on the page numbers acquired by the acquiring unit, and a document generating unit that generates a document corresponding to the document ID of an electronic document of a print source based on the scan data sorted by the sorting unit, however, this image processing program may be provided with it stored in a storing medium such as CDMROM.

What is claimed is:

1. An image processing system comprising:
an extracting unit that extracts page identification information from image information;
an acquiring unit that acquires document identification information corresponding to the page identification information on the basis of the page identification information extracted by the extracting unit;
a classifying unit that classifies the image information on the basis of the document identification information acquired by the acquiring unit; and
a first generating unit that generates the image information classified by the classifying unit as one electronic document.

2. The image processing system according to claim 1, further comprising:
a managing unit that manages the document identification information of an electronic document in correspondence to the page identification information given to a sheet document on which the electronic document is printed,
wherein the acquiring unit acquires the document identification information from the managing unit.

3. The image processing system according to claim 1, further comprising:
a reading unit that reads the image information including the page identification information from a sheet document to which the page identification information is given,
wherein the extracting unit extracts the page identification information from the image information read by the reading unit; and
the classifying unit that classifies the image information read by the reading unit.

4. The image processing system according to claim 1, further comprising:
a print unit that gives the page identification information identifying pages of a sheet document to the pages of the sheet document and prints an electronic document as the sheet document.

5. The image processing system according to claim 1, further comprising:
a second generating unit that generates new document identification information corresponding to the electronic document generated by the first generating unit; and
a storing unit that stores the electronic document generated by the first generating unit in correspondence to the document identification information generated by the second generating unit.

6. The image processing system according to claim 1, further comprising:
a second generating unit that generates new document identification information in correspondence to the electronic document generated by the first generating unit;
a third generating unit that generates new page identification information in correspondence to a print page of the electronic document generated by the first generating unit; and
a print unit that gives the document identification information generated by the second generating unit and the page identification information generated by the third generating unit to the electronic document generated by the first generating unit, and prints the electronic document.

7. An image processing system comprising:
an extracting unit that extracts page identification information from image information;
an acquiring unit that acquires page number information corresponding to the page identification information on the basis of the page identification information extracted by the extracting unit;
a sorting unit that sorts the image information on the basis of the page number information acquired by the acquiring unit; and
a first generating unit that generates the image information sorted by the sorting unit as one electronic document.

8. The image processing system according to claim 7, further comprising:
a managing unit that manages the page number information of an electronic document in correspondence to the page identification information given to a sheet document on which the electronic document is printed,
wherein the acquiring unit acquires the page number information from the managing unit.

9. The image processing system according to claim 7, further comprising:
a reading unit that reads the image information including the page identification information from a sheet document to which the page identification information is given,
wherein the extracting unit extracts the page identification information from the image information read by the read unit; and
the sorting unit sorts the image information read by the read unit.

10. The image processing system according to claim 7, further comprising:
a print unit that gives the page identification information identifying pages of a sheet document to the pages of the sheet document and prints an electronic document as the sheet document.

11. The image processing system according to claim 7, further comprising:
a second generating unit that generates new document identification information corresponding to the electronic document generated by the first generating unit; and
a storing unit that stores the electronic document generated by the first generating unit in correspondence to the document identification information generated by the second generating unit.

12. The image processing system according to claim 7, further comprising:
a second generating unit that generates new document identification information in correspondence to the electronic document generated by the first generating unit;
a third generating unit that generates new page identification information in correspondence to a print page of the electronic document generated by the first generating unit; and
a print unit that gives the document identification information generated by the second generating unit and the page identification information generated by the third generating unit to the electronic document generated by the first generating unit, and prints the electronic document.

13. An image processing system comprising:
an extracting unit that extracts page identification information from image information;
an acquiring unit that acquires document identification information and page number information corresponding to the page identification information on the basis of the page identification information extracted by the extracting unit;
a classifying unit that classifies the image information on the basis of the document identification information acquired by the acquiring unit;
a sorting unit that sorts the image information, which is classified by the classifying unit and corresponds to the document identification information, on the basis of the page number information acquired by the acquiring unit; and
a first generating unit that generates an electronic document corresponding to the document identification of the electronic document on the basis of the image information sorted by the sorting unit.

14. The image processing system according to claim 13, further comprising:
a managing unit that manages the document identification information and the page number information of an electronic document in correspondence to the page identification information given to a sheet document on which the electronic document is printed,
wherein the acquiring unit acquires the document identification information and the page number information from the managing unit.

15. The image processing system according to claim 13, further comprising:
a reading unit that reads the image information including the page identification information from a sheet document to which the page identification information is given,
wherein the extracting unit extracts the page identification information from the image information read by the read unit; and
the classifying unit classifies the image information read by the reading unit.

16. The image processing system according to claim 13, further comprising:
a print unit that gives the page identification information identifying pages of a sheet document to the pages of the sheet document and prints an electronic document as the sheet document.

17. The image processing system according to claim 13, further comprising:
a second generating unit that generates new document identification information corresponding to the electronic document generated by the first generating unit; and
a storing unit that stores the electronic document generated by the first generating unit in correspondence to the document identification information generated by the second generating unit.

18. The image processing system according to claim 13, further comprising:
a second generating unit that generates new document identification information in correspondence to the electronic document generated by the first generating unit;
a third generating unit that generates new page identification information in correspondence to a print page of the electronic document generated by the first generating unit; and
a print unit that gives the document identification information generated by the second generating unit and the page identification information generated by the third generating unit to the electronic document generated by the first generating unit, and prints the electronic document.

19. An image processing method comprising:
extracting page identification information given to a sheet document from image information read from the sheet document;
acquiring document identification information and page number information corresponding to the page identification information on the basis of the extracted page identification information;
classifying the image information on the basis of the acquired document identification information;
sorting the image information, which is classified and corresponds to the document identification information, on the basis of the acquired page number information; and
generating an electronic document corresponding to the document identification of an electronic document on the basis of the sorted image information.

20. A computer readable medium storing a program causing a computer to execute a process for performing an image processing, the process comprising:
extracting page identification information given to a sheet document from image information read from the sheet document;
acquiring document identification information and page number information corresponding to the page identification information on the basis of the extracted page identification information;
classifying the image information on the basis of the acquired document identification information;
sorting the image information, which is classified and corresponds to the document identification information, on the basis of the acquired page number information; and
generating an electronic document corresponding to the document identification of an electronic document on the basis of the sorted image information.
